(19) United States
(12) Patent Application Publication
(10) Pub. No.: US 2024/0273586 A1
(43) Pub. Date: Aug. 15, 2024

(54) INFORMATION PROCESSING APPARATUS, INFORMATION PROCESSING METHOD, AND PROGRAM

(71) Applicant: Sony Group Corporation, Tokyo (JP)

(72) Inventors: Shogo KIMURA, Tokyo (JP); Nao YAMATO, Kanagawa (JP); Reiko KIRIHARA, Tokyo (JP)

(73) Assignee: Sony Group Corporation, Tokyo (JP)

(21) Appl. No.: 18/577,902

(22) PCT Filed: Feb. 22, 2022
(86) PCT No.: PCT/JP2022/007275

§ 371 Date: Jan. 9, 2024

(30) Foreign Application Priority Data
Jul. 21, 2021 (JP) 2021-120673

(51) Int. Cl. G06Q 30/0283

(52) U.S. Cl. CPC G06Q 30/0283

(57) ABSTRACT

Provided are an information processing apparatus, an information processing method, and a program capable of outputting information regarding correction of a setting element for content generation according to a target of a value generated by the content.

The information processing apparatus includes a control unit that performs: a process of estimating a value caused by content on the basis of information of one or more of setting element set for generating the content; a process of comparing the estimated value estimated with a target value; and a process of outputting correction information regarding correction of the setting element on the basis of a result of comparison.

### TECHNICAL FIELD

The present disclosure relates to an information processing apparatus, an information processing method, and a program.

### BACKGROUND ART

In recent years, a cloud service that automatically generates a sentence by artificial intelligence (AI) on the basis of some input keywords, software that supports scenario production that describes an order of scene changes in a story, lines, and the like, and the like have been proposed. For example, Patent Document 1 below discloses a technique capable of quickly searching and grasping similar stories by analyzing a narrative content of a story in various forms such as a book and a movie and graphically expressing a relationship between a story in which the user is interested and many other stories.

### CITATION LIST

### Patent Document

Patent Document 1: Japanese Unexamined Patent Application Publication No. 2014-507699

### SUMMARY OF THE INVENTION

### Problems to be Solved by the Invention

However, it has required many years of experience of a producer to assume a predetermined value caused by content (for example, video) as a result during production of a script (scenario) of a story or at a stage of considering setting (characters, locations, and the like) of a story.

Therefore, the present disclosure proposes an information processing apparatus, an information processing method, and a program capable of outputting information regarding correction of a setting element for content generation according to a target of a value generated by the content.

### Solutions to Problems

According to the present disclosure, there is proposed an information processing apparatus including a control unit that performs: a process of estimating a value caused by content on the basis of information of one or more of setting element set for generating the content; a process of comparing the estimated value estimated with a target value; and a process of outputting correction information regarding correction of the setting element on the basis of a result of comparison.

According to the present disclosure, there is proposed an information processing method including a processor that performs: estimating a value caused by content on the basis of information of one or more of setting element set for generating the content; comparing the estimated value estimated with a target value; and outputting correction information regarding correction of the setting element on the basis of a result of comparison.

According to the present disclosure, there is proposed a program for causing a computer to function as a control unit that performs: a process of estimating a value caused by content on the basis of information of one or more of setting element set for generating the content; a process of comparing the estimated value estimated with a target value; and a process of outputting correction information regarding correction of the setting element on the basis of a result of comparison.

### BRIEF DESCRIPTION OF DRAWINGS

FIG. 1 is a block diagram illustrating an example of a basic configuration of an information processing apparatus according to an embodiment of the present disclosure.

FIG. 2 is a block diagram illustrating a configuration example of a control unit according to the first embodiment.

FIG. 3 is a flowchart illustrating an example of a flow of operation processing according to the first embodiment.

FIG. 4 is a diagram for explaining learning of a temporal length for each setting element of a past work according to the first embodiment.

FIG. 5 is a diagram for explaining estimation of a temporal length for each setting element of a current work according to the first embodiment.

FIG. 6 is a diagram for explaining a case of selecting a setting element to be added from a past work according to the first embodiment.

FIG. 7 is a diagram illustrating a display example of a setting element change proposal according to the first embodiment.

FIG. 8 is a diagram for explaining tagging processing according to the first embodiment.

FIG. 9 is a diagram illustrating a screen example of displaying a range that affects a scenario by deletion of a setting element according to the first embodiment.

FIG. 10 is a diagram illustrating a screen example of displaying a history of changes made according to proposal according to the first embodiment.

FIG. 11 is a diagram for explaining an example of screen transition in scenario production support according to the first embodiment.

FIG. 12 is a diagram illustrating an example of a title and outline determination screen according to the first embodiment.

FIG. 13 is a diagram illustrating an example of a genre selection screen according to the first embodiment.

FIG. 14 is a diagram illustrating an example of a setting screen for characters according to the first embodiment.

FIG. 15 is a diagram illustrating an example of a location setting screen according to the first embodiment.

FIG. 16 is a diagram illustrating an example of a setting screen of details (large props, props, and the like) according to the first embodiment.

FIG. 17 is a diagram illustrating an example of an editing screen of a beat sheet according to the first embodiment.

FIG. 18 is a diagram illustrating an example of an editing screen of a development plot according to the first embodiment.

FIG. 19 is a diagram illustrating an example of a scenario editing screen according to the first embodiment.

FIG. 20 is a diagram for explaining a case where a person correlation according to the first embodiment is proposed in units of correlation diagrams as a reference.

FIG. 21 is a block diagram illustrating a configuration example of a control unit according to the second embodiment.

FIG. 22 is a flowchart illustrating an example of an overall flow of operation processing according to the second embodiment.

FIG. 23 is a flowchart illustrating an example of a flow of extraction processing according to the second embodiment.

FIG. 24 is a flowchart illustrating an example of a flow of estimation processing according to the second embodiment.

FIG. 25 is a diagram illustrating an example of a character table according to the second embodiment.

FIG. 26 is a diagram illustrating an example of a location table according to the second embodiment.

FIG. 27 is a diagram illustrating an example of a large props/props table according to the second embodiment.

FIG. 28 is a diagram for explaining same-element determination according to the second embodiment.

FIG. 29 is a diagram illustrating an example of a data configuration of a past work component DB according to the second embodiment.

FIG. 30 is a diagram illustrating an example of attribute definition of time-series metadata (component) according to the second embodiment.

FIG. 31 is a diagram illustrating an example of a detailed definition of “sentence elements” included in time-series metadata according to the second embodiment.

FIG. 32 is a flowchart illustrating an example of a flow of processing of importance determination and labeling according to the second embodiment.

FIG. 33 is a diagram illustrating an example of an editing screen on which importance and labels of components in a scene according to the second embodiment can be edited.

FIG. 34 is a diagram illustrating an example of an importance confirmation screen for each scene of appearance of a component according to the second embodiment.

FIG. 35 is a diagram illustrating an example of an editing screen of a component (large props) according to the second embodiment.

FIG. 36 is a diagram illustrating an example of an editing screen of a component (large props) according to the second embodiment.

FIG. 37 is a diagram illustrating an example of an editing screen of a component (character) according to the second embodiment.

FIG. 38 is a flowchart illustrating an example of a flow of search processing of a past work based on a place according to an application example of the second embodiment.

FIG. 39 is a flowchart illustrating an example of a flow of performer search processing according to an application example of the second embodiment.

FIG. 40 is a flowchart illustrating an example of a processing flow of a CG production expense trial calculation according to an application example of the second embodiment.

FIG. 41 is a flowchart illustrating an example of a flow of processing of a shooting cost trial calculation according to an application example of the second embodiment.

FIG. 42 is a diagram illustrating an example of a location table of a work A according to an application example of the second embodiment.

### MODE FOR CARRYING OUT THE INVENTION

Preferred embodiments of the present disclosure are hereinafter described in detail with reference to the accompanying drawings. Note that, in the present specification and the drawings, components having substantially the same functional configuration are denoted by the same reference sign, and redundant descriptions are omitted.

Furthermore, descriptions will be given in the following order.

1. Overview

2. Basic Configuration

3. First Embodiment
3-1. Configuration Example
3-2. Operation Processing
3-3. Display Screen Example
3-4. Application Example

4. Second Embodiment
4-1. Configuration Example
4-2. Operation Processing
4-3. Display Screen Example
4-4. Application Example

5. Supplement

### 1. Overview

In an embodiment of the present disclosure, information regarding correction of a setting element for content generation is output according to a target of a predetermined value caused by content. In the present specification, examples of the content include moving images such as a movie, a commercial message (CM), a drama, a documentary, an animation, and a distributed video, music, a play, and speech. It is assumed that they are generated on the basis of a scenario (script). The scenario is a text describing a story of content. For example, a scenario used for generating a moving image may include “scene heading” for describing a place and a time zone, “stage direction” for describing an action of an actor or a change of a stage (scene), and “line” for describing a word spoken by the actor. Shooting is performed according to the description of the scenario, and the scenario is imaged, that is, a moving image is generated.

Furthermore, the “setting element for content generation” is information serving as a basis of a story. Examples thereof include a stage (period and place), a character (correlation), a tool (large props and props), and the like.

Further, the “predetermined value caused by the content” is assumed variously. For example, the temporal length of the moving image obtained by imaging the scenario, the cost required for creating the moving image (the shooting time and the shooting expense. hereinafter, referred to as shooting cost), or income from the moving image (for example, box-office revenue of a movie, revenue from reproduction of a moving image, and the like).

(Review of Problems)

In production of a movie, an animation, or the like, generally, a scenario is first produced, and shooting or animation production is performed on the basis of the produced scenario, but the length of a video is often determined in advance. It depends on the experience of the scenario producer to determine how much content is optimally included in the scenario so as to meet the determined length. Furthermore, although the budget of the shooting cost is often determined in advance, whether or not a scenario that falls within the determined shooting cost can be produced also depends on the experience of the producer. In addition, what elements should be included in the scenario to be popular and profitable also depends on the experience of the producer.

In a case where an appropriate determination is not made during the production of the scenario, a large rework such as changing the content after shooting occurs, and thus, it is desirable to more accurately estimate before imaging, that is, at the stage of scenario production. In addition, in recent years, moving image distribution services have become widespread, and it has become easy for an amateur creator who has no experience of creating moving images to image the scenarios and publish them. Even in such an environment, there may be a target value such as a desire to create a video of a predetermined length that is likely to be popular, such as within 10 minutes. Even an inexperienced user can produce better content if a predetermined value such as a temporal length of a video at the time of being imaged can be estimated more accurately at the stage of scenario production.

Therefore, in the present embodiment, information regarding correction of a setting element for content generation is output according to a target of a predetermined value generated by the content. More specifically, in the present embodiment, at the stage of producing the scenario or deciding the setting of the story, a predetermined value (for example, temporal length, shooting cost, revenue, or the like) generated by the content (for example, video) as a result is estimated, the estimated value is compared with the target value, and correction of the setting element (addition or deletion of the setting element) is presented to the user on the basis of the comparison result. This can support creation of better content.

### 2. Basic Configuration

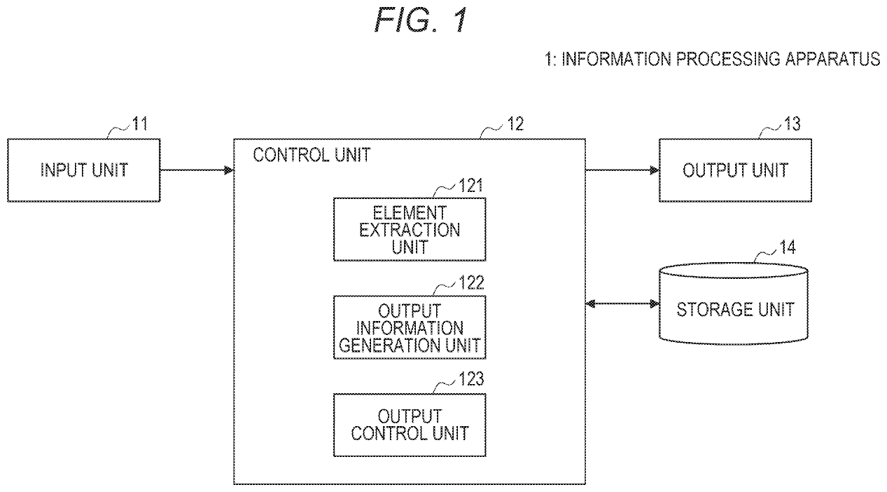

Next, a basic configuration of an information processing apparatus 1 that supports content creation according to the present embodiment will be described with reference to FIG. 1. FIG. 1 is a block diagram illustrating an example of a basic configuration of the information processing apparatus 1 according to an embodiment of the present disclosure.

As illustrated in FIG. 1, the information processing apparatus 1 includes an input unit 11, a control unit 12, an output unit 13, and a storage unit 14.

(Input Unit 11)

The input unit 11 has a function of receiving an input of information to the information processing apparatus 1. The input unit 11 may be a communication unit that receives information from an external device or an operation input unit that receives an operation input by the user. The operation input unit can be implemented by, for example, a mouse, a keyboard, a touch panel, a switch, a microphone (voice input), or the like. The input unit 11 according to the present embodiment receives, for example, information (text data) of a scenario being produced, input of information of an element, and a target value (for example, the temporal length of the content, the shooting cost, the revenue, and the like). The scenario being produced may be, for example, a scenario in which the story generally includes three acts (act 1-start (situation setting), act 2-middle (conflict), act 3-end (solution)), but may be a scenario up to description of act 1. Furthermore, the scenario being produced may be a scenario in which description is made up to the middle of act 1 or act 2.

(Control Unit 12)

The control unit 12 functions as an arithmetic processing device and a control device, and controls the overall operation in the information processing apparatus 1 according to various programs. The control unit 12 is implemented by, for example, an electronic circuit such as a central processing unit (CPU) or a microprocessor. Furthermore, the control unit 12 may include a read only memory (ROM) that stores programs, operation parameters, and the like to be used, and a random access memory (RAM) that temporarily stores parameters and the like that change appropriately.

Furthermore, the control unit 12 according to the present embodiment also functions as an element extraction unit 121, an output information generation unit 122, and an output control unit 123. The element extraction unit 121 has a function of extracting an element of a story from the information of the scenario. Even in a case where no element is input from the input unit 11, it is possible to extract an element from the scenario information. The element extraction unit 121 analyzes scenario information (text data), and extracts elements such as characters (correlation), a stage (period and place), and tools (large props and props). For example, natural language processing may be used for the analysis. The element extraction unit 121 can perform natural language processing (morphological analysis, syntax analysis, anaphoric analysis, and the like) on descriptions such as scene headings, stage directions, and lines included in the scenario information to extract the elements as described above.

The output information generation unit 122 generates output information to be presented to the user on the basis of the information of the element. The output information to be presented to the user is information for supporting better scenario production. More specifically, for example, the output information generation unit 122 estimates a predetermined value generated by the generated content on the basis of the information of the set element (setting element) constituting the story, compares the estimated value with the target value input from the input unit 11, and generates information regarding correction of the setting element on the basis of the comparison result. The information regarding the correction of the setting element is information about addition or deletion of the setting element. The output information generation unit 122 determines addition or deletion of the setting element so as to bring the value closer to the target value on the basis of the comparison result between the estimated value and the target value. For example, the output information generation unit 122 estimates the temporal length of the content at the time of being imaged on the basis of the information of the setting element. Then, the output information generation unit 122 compares the temporal length input as the target value with the estimated temporal length, and determines addition or deletion of a setting element for bringing the temporal length closer to the target temporal length according to the comparison result. For example, the output information generation unit 122 determines the setting element to be deleted in a case where the estimated temporal length is longer than the target temporal length, and determines the setting element to be added in a case where the estimated temporal length is shorter than the target temporal length.

Furthermore, as another example of information for supporting better scenario production, the output information generation unit 122 can generate information for generating a simulation video (so-called pre visualization) for imagining a completed state before content production such as actual shooting or CG production. Such a simulation video can be created with a simple computer graphics (CG) model. Furthermore, the simulation video can be referred to when determining camerawork, character arrangement, visual effects (VFX), editing, and the like in advance. The output information generation unit 122 can generate the information necessary for the processing of visualizing the scenario with the simulation video by analyzing the information (text data) of the scenario. Specifically, the output information generation unit 122 performs, for example, natural language processing (morphological analysis, syntax analysis, anaphoric analysis, and the like) on the information of the scenario and extracts an element for visualization (elements constituting the story; components). As the components, similarly to the above-described setting elements, characters, a stage (period and place), tools (large props and props), and the like constituting the story are assumed. The output information generation unit 122 can perform visualization processing (automatic generation of a simulation video by a simple CG) on the basis of the extracted components and generate a simulation video as output information. In the visualization processing, an image corresponding to a component is searched or automatically generated, and is visualized (imaged) for each scene. At this time, the output information generation unit 122 may acquire images corresponding to the respective components after being divided into components that can be corrected and operated by the user and components that are automatically generated. For example, the output information generation unit 122 uses a 3DCG asset (model data) prepared in advance for a component enabling correction and operation by the user. The distinction between such components can be determined according to the importance of the components, for example. A component whose importance is higher than a threshold (or determined to be important) is an “important element” and is treated as a correctable/operable component. As a result, the user can correct and operate the appearance, position, and the like of the correctable/operable 3DCG included in the simulation video visualized for each scene via the input unit 11.

The output control unit 123 controls the output unit 13 to output the output information generated by the output information generation unit 122.

(Output Unit 13)

The output unit 13 has a function of outputting information. For example, the output unit 13 may be a display unit, an audio output unit, a projector, a communication unit, or the like.

(Storage Unit 14)

The storage unit 14 is implement by a read only memory (ROM) that stores programs, operation parameters, and the like used for processing of the control unit 12, and a random access memory (RAM) that temporarily stores parameters and the like that change appropriately.

The basic configuration of the information processing apparatus 1 according to the present embodiment has been described above. Note that the basic configuration of the information processing apparatus 1 is not limited to the example illustrated in FIG. 1. For example, the information processing apparatus 1 may be implemented by a plurality of devices. Specifically, for example, the control unit 12 and the storage unit 14 may be provided in a server, and the input unit 11 and the output unit 13 may be provided in a user terminal (PC, smartphone, head mounted display (HMD), or the like).

Next, more specific contents of support of scenario production according to the present embodiment will be described.

### 3. First Embodiment

In the first embodiment, information (proposal content) regarding correction of a setting element is output as support of scenario production. Hereinafter, the configuration and operation processing of the first embodiment will be sequentially described.

### 3-1. Configuration Example

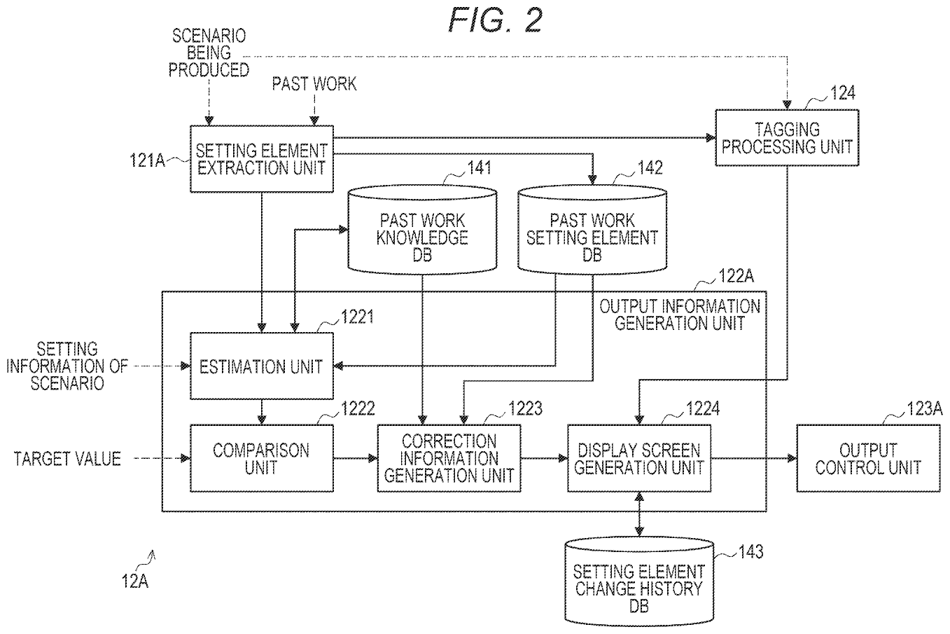

FIG. 2 is a block diagram illustrating a configuration example of a control unit 12A according to the first embodiment. As illustrated in FIG. 2, the control unit 12A includes a setting element extraction unit 121A, an output information generation unit 122A, an output control unit 123A, and a tagging processing unit 124. In addition, the output information generation unit 122A functions as an estimation unit 1221, a comparison unit 1222, a correction information generation unit 1223, and a display screen generation unit 1224. Note that, in the example illustrated in FIG. 2, the past work knowledge DB 141, the past work setting element DB 142, and the setting element change history DB 143, which are databases (DBs) included in the storage unit 14, are also illustrated for the sake of description.

### (Setting Element Extraction Unit 121A)

The setting element extraction unit 121A extracts the information of the setting element from the information of the scenario. For example, the setting element extraction unit 121A performs natural language processing on scenario information (text data) of a given past work (for example, a movie), extracts information of setting elements such as characters, periods, places, large props/props in the past work, and stores the information in the past work setting element DB 142. Furthermore, also in a case where the scenario information being produced is input, the setting element extraction unit 121A similarly performs natural language processing on the scenario information to extract information of the setting element, and outputs the information to the estimation unit 1221.

For example, as extraction of characters, the setting element extraction unit 121A extracts information such as a name of a person, a line list of the person, an action list (obtained from verbs) of the person, and person setting (relationship with a main character). In addition, the setting element extraction unit 121A assigns the person ID and the importance to the extracted characters. The importance is the importance of the person in the story, and can be determined from, for example, the amount of lines, the number of appearance scenes, person setting, and the like. The setting element extraction unit 121A determines a person with high importance as a main person (Main) and a person with low importance as a supporting person (Sub). Such a determination criterion is not particularly limited.

(Estimation Unit 1221)

On the basis of the information of the setting element, the estimation unit 1221 estimates a value generated by the content generated on the basis of the setting element. The value generated by the content is, for example, a temporal length, a shooting cost, a revenue, or the like at the time of imaging. The information of the setting element may be information extracted from the information of the scenario being produced by the setting element extraction unit 121A, or may be information of the setting element input by the user. The setting element extraction unit 121A may perform estimation only with the information of the setting element input by the user (for example, the name of the person and the person setting), or may further perform estimation using the information of the setting element extracted from the information of the scenario by the natural language processing (for example, further, a line list and an action list) in a case where the information of the scenario is input. The more information input, the higher the accuracy of estimation.

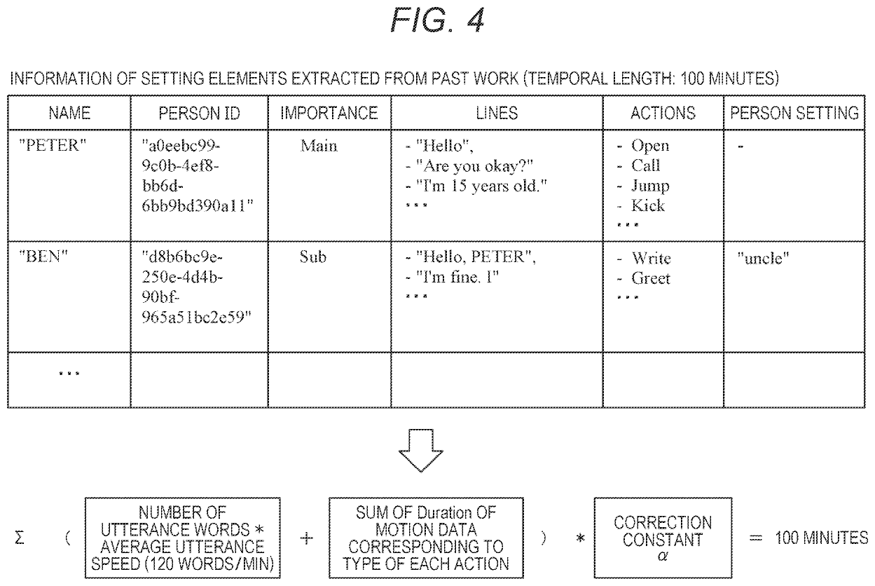

The estimation can be performed using, for example, a learning result of a past work. Since the temporal length, the shooting cost, the revenue, and the like of the past work are known, various values for each setting element can be calculated on the basis of the information of the setting element of the past work and the known information. Such learning may be performed in advance, and a learning result may be stored in the past work setting element DB 142. Furthermore, the estimation unit 1221 may perform estimation (learning) on the basis of the information of the setting element of the past work stored in the past work setting element DB 142 and the information of the temporal length, the shooting cost, the revenue, and the like of the past work stored in the past work knowledge DB 141. The estimation unit 1221 estimates a value that can be caused by the information of the setting element of the current work from the value associated with the information of the same setting element in the past work on the basis of the information of the setting element of the current work. A more specific content of the estimation according to the present embodiment will be described later (see FIGS. 4 to 6).

(Comparison Unit 1222)

The comparison unit 1222 compares the estimated value estimated (calculated) by the estimation unit 1221 with the target value. The target value may be input by the user or may be set in advance. For example, in a case where the temporal length is estimated to be “8 minutes” by the estimation unit 1221 on the basis of the information of the setting element of the current work and the target value is “10 minutes”, the comparison unit 1222 outputs a comparison result indicating “2 minutes short”.

(Correction Information Generation Unit 1223)

The correction information generation unit 1223 generates information (correction information) regarding correction of the setting element such as addition or deletion of the setting element on the basis of the comparison result by the comparison unit 1222. For example, the correction information generation unit 1223 determines addition of a setting element in a case where the estimated value is less than the target value according to the comparison result, and determines deletion of the setting element in a case where the estimated value exceeds the target value. The correction information generation unit 1223 can determine the setting element to be added or deleted on the basis of information of the setting element obtained from the past work setting element DB 142 (the temporal length of each setting element, or the like), the magnitude of revenue of the past work obtained from the past work knowledge DB 141, or the like. More specific content of the correction information generation according to the present embodiment will be described later.

(Display Screen Generation Unit 1224)

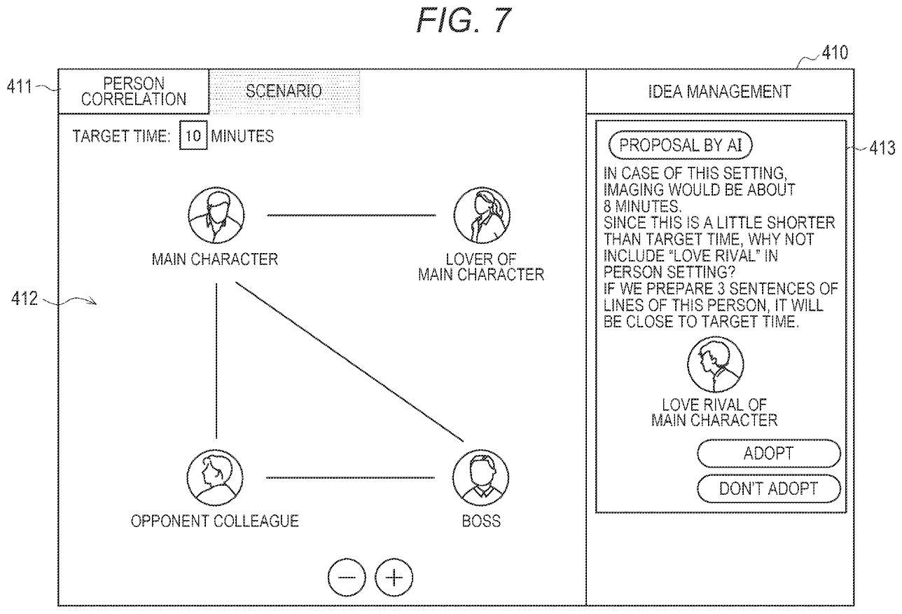

The display screen generation unit 1224 generates a display screen used when the correction information generated by the correction information generation unit 1223 is presented to the user, and outputs the display screen to the output control unit 123A. For example, the display screen generation unit 1224 may generate a screen that indicates a comparison result between the temporal length estimated from the current person setting and the target value on the person setting screen (an example of the input screen of the setting element) and displays a sentence proposing a setting element (for example, a new character) to be added/deleted as “proposal by AI” (see FIG. 7).

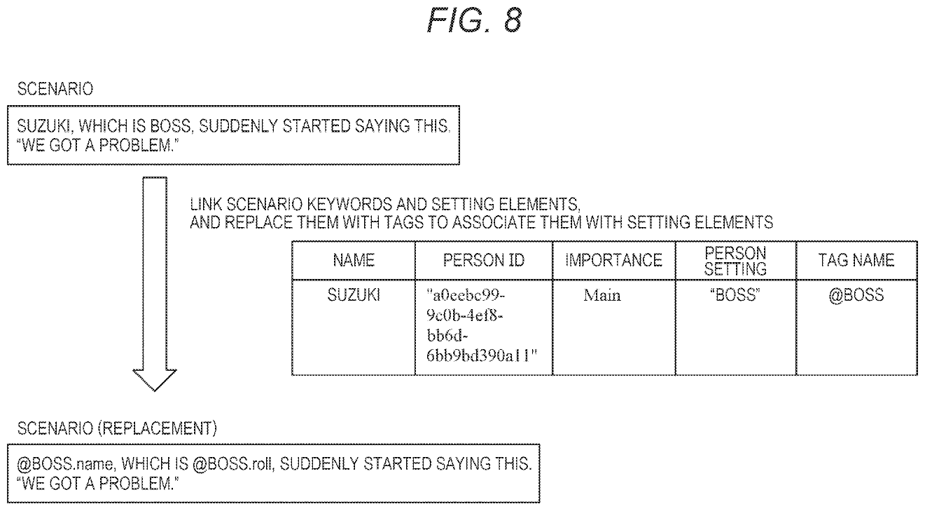

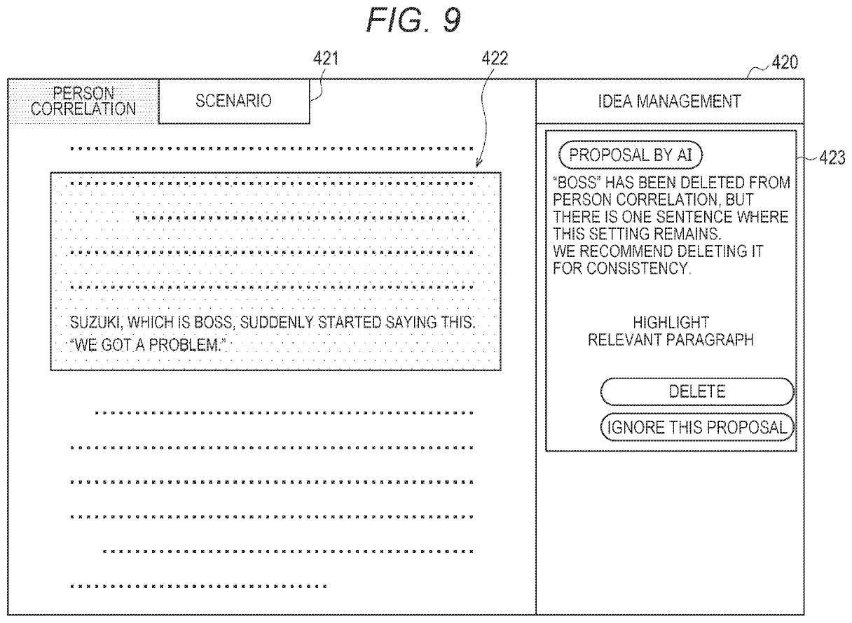

Furthermore, in a case where there is a scenario being produced (in a case where information on the scenario being produced is input), the display screen generation unit 1224 may generate a screen indicating which part of the scenario body is affected when the correction of the setting element is adopted by the user. Note that the display screen generation unit 1224 updates the display screen as needed according to the user operation, for example, in a case where an instruction to change the setting element (operation input to adopt correction of the proposed setting element) is issued. Here, in particular, in a case where deletion of a setting element is adopted, there is a case where consistency cannot be obtained unless a related sentence is deleted. The display screen generation unit 1224 changes the setting element (for example, in a case where the user adopts deletion of the proposed setting element), performs body searching processing, specifies a sentence to which the setting element is referred (for example, a sentence in which the name of the setting element appears), and generates a display screen that clearly indicates the sentence to the user and displays the sentence prompting deletion or correction. Note that, in the scenario body, the same setting element may be expressed by different words. For example, there are cases where the same person is described by the name, cases where the same person is expressed by the position of the person, and the like. Therefore, the display screen generation unit 1224 may perform the body searching processing with reference to the processing result (see FIG. 8) by the tagging processing unit 124 that associates the scenario body with the setting element. More specifically, the display screen generation unit 1224 performs the body searching processing of the setting element to be deleted on the scenario body on which the tagging processing has been performed, and specifies the sentence (the portion to which the tag of the setting element is assigned) associated with the setting element (see FIG. 9). Whether the specific range is set for each sentence or each paragraph can be arbitrarily set by the user.

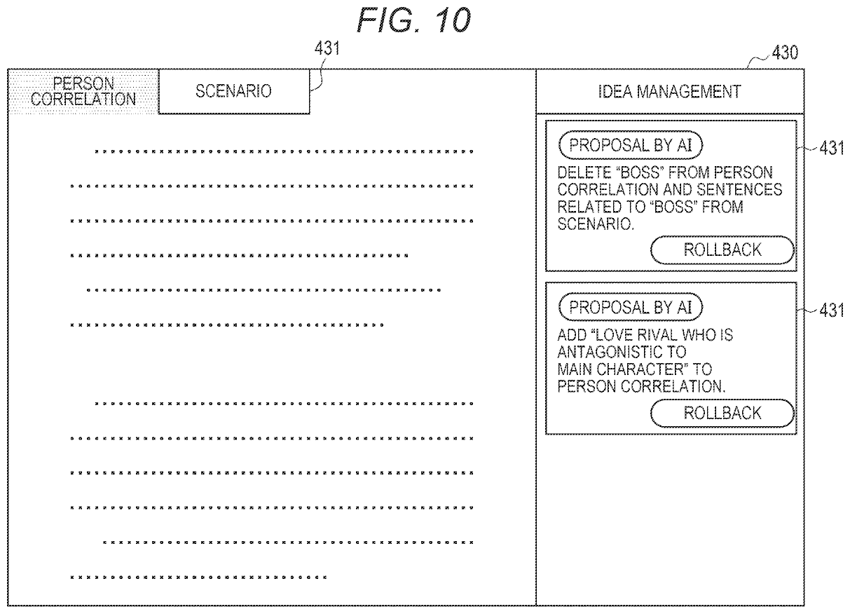

Furthermore, a case where the user incorporates correction (addition/deletion) of the proposed setting element but wants to undo it later, or a case where the user does not incorporate the correction (addition/deletion) of the proposed setting element but wants to incorporate the correction (addition/deletion) of the proposed setting element later is also assumed. Therefore, in the present embodiment, the correction information (proposal content) generated by the correction information generation unit 1223 and the scenario body and the change content of the setting element by the user (contents before acceptance of proposal, addition, deletion, change, or the like) are stored in the setting element change history DB 143 as a history. The display screen generation unit 1224 may refer to the information stored in the setting element change history DB 143 and display the proposal content adopted so far and the editing content corresponding thereto on a part of the display screen, for example, by a card type user interface (UI) (see FIG. 10). As a result, when the user desires to undo the change regarding each setting element, the user selects the “rollback” button, and the control unit 12A returns the scenario to the state before the change is performed (rollback; backward reversion). Note that the display screen generation unit 1224 may also generate a screen to be displayed on a card type UI for a proposal content that has been proposed but has not been adopted. The user can change the setting element of the scenario by selecting the “adopt” button of the card type UI at any time.

(Tagging Processing Unit 124)

The tagging processing unit 124 performs the process of associating (tagging) the setting element with the scenario body on the basis of the input information on the scenario being produced and the information on the setting element extracted from the scenario. As described above, for example, there are a case where the same person is described by the name (“name” of the setting element) and a case where the same person is expressed by the position of the person (“person setting” of the setting element). However, by tagging words of the scenario body by the tagging processing unit 124, it becomes clear that one setting element corresponds to one or more different words appearing in the scenario body. A specific example of the tag processing will be described later with reference to FIG. 8.

(Output Control Unit 123A)

The output control unit 123A performs control to display the display screen generated by the display screen generation unit 1224 on, for example, a display unit (an example of the output unit 13).

The configuration example of the control unit 12A according to the first embodiment has been described above. Note that the configuration illustrated in FIG. 2 is an example, and the present embodiment is not limited thereto.

### 3-2. Operation Processing

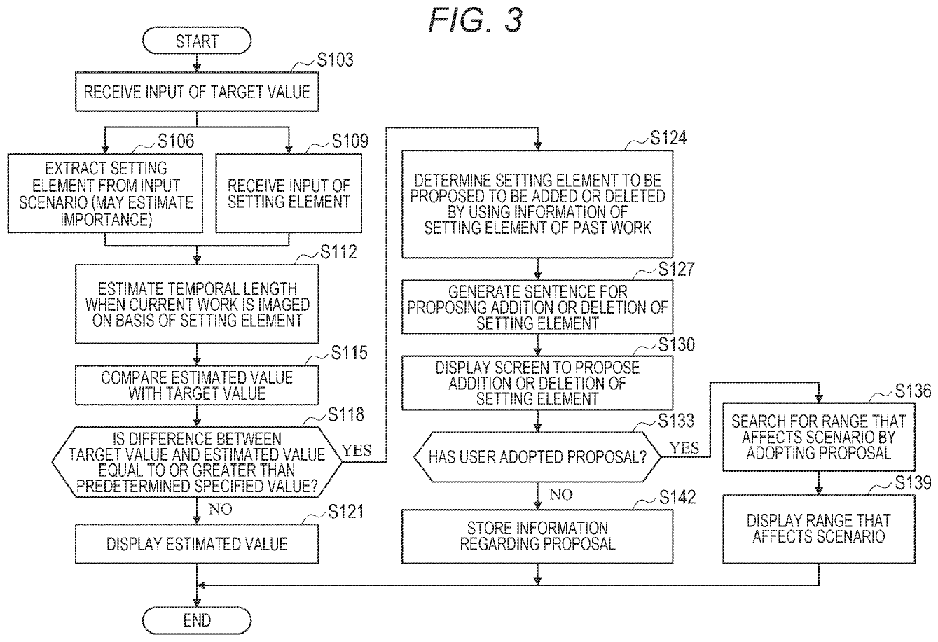

FIG. 3 is a flowchart illustrating an example of a flow of operation processing according to the first embodiment.

As illustrated in FIG. 3, first, the control unit 12A of the information processing apparatus 1 receives an input of a target value from the input unit 11 (step S103). In this flow, as an example, a case where a “temporal length when a scenario is imaged” is input as a target value will be described.

Next, the setting element extraction unit 121A of the control unit 12A performs natural language processing on the input information (text data) of the scenario being produced (current work), and extracts information of setting elements such as characters (name of person, person setting, line list, action list, and the like), periods, and places (step S106). At this time, the setting element extraction unit 121A may calculate the importance of each setting element on the basis of the content of the scenario. The importance is calculated (determined) on the basis of the person setting (main character, lover of main character, opponent of main character, or the like), the number of appearances in the scenario, whether or not the number of conversations of the person is large, whether or not the depiction of the setting element is fine, and the like. The setting element extraction unit 121A gives a determination result of “Main” in a case where the importance is higher (than the threshold) and “Sub” in a case where the importance is lower (than the threshold) to each setting element.

In addition, the control unit 12A receives an input of a (current work) setting element from the input unit 11 (step S109). In the present embodiment, the user may input only the setting element, or may input information of a scenario being produced and cause the information processing apparatus 1 to extract the setting element. Furthermore, the user may input both the information of the scenario being produced and the setting element.

Next, the estimation unit 1221 estimates a temporal length when the current work is imaged on the basis of the acquired information of the setting element (step S112). Although various estimation methods are assumed, in this flow, as an example, a case where the estimation is performed by learning the setting element of the past work and the temporal length of the video of the past work will be described. More specifically, the estimation unit 1221 calculates the temporal length of each setting element on the basis of the information of the setting element extracted from the scenario of the past work and the temporal length of the past work. Note that such calculation may be performed in advance. Hereinafter, descriptions will be given with reference to FIG. 4.

FIG. 4 is a diagram for explaining learning of a temporal length for each setting element of a past work according to the first embodiment. First, since the temporal length of the past work is known, the formula illustrated in FIG. 4 is established on the basis of the number of utterance words of each person and the type of action of each person. That is, from the list of lines and the list of actions (list of verbs) of each person obtained by extracting the setting element, the time (reproduction time) when these are imaged is estimated. A statistical value of an average utterance speed in each language may be used for estimating the reproduction time of the line. In addition, for estimating the reproduction time of the action, a corresponding motion may be searched from a database (not illustrated) in which separately prepared motion data is collected, and the reproduction time of the motion may be used. In the case of motion that does not exist in the database, an average value of reproduction times of all motion data may be used. In addition, since there is a difference in the speed of movement, a time between actions, and the like, and a simple addition does not match the temporal length when the images are actually captured, the correction constant is prepared and multiplied to calculate the correction constant so as to match the temporal length of the work (100 minutes in the example illustrated in FIG. 4). Such a correction constant varies depending on various conditions, but here, as an example, an average correction constant for each genre of a movie is calculated. The estimation unit 1221 can execute the calculation formula illustrated in FIG. 4 for a large number of past works and calculate the average correction constant for each movie genre. Note that there is a tendency in the average correction constant for each movie genre, and for example, this value is large in a horror and is small in an action.

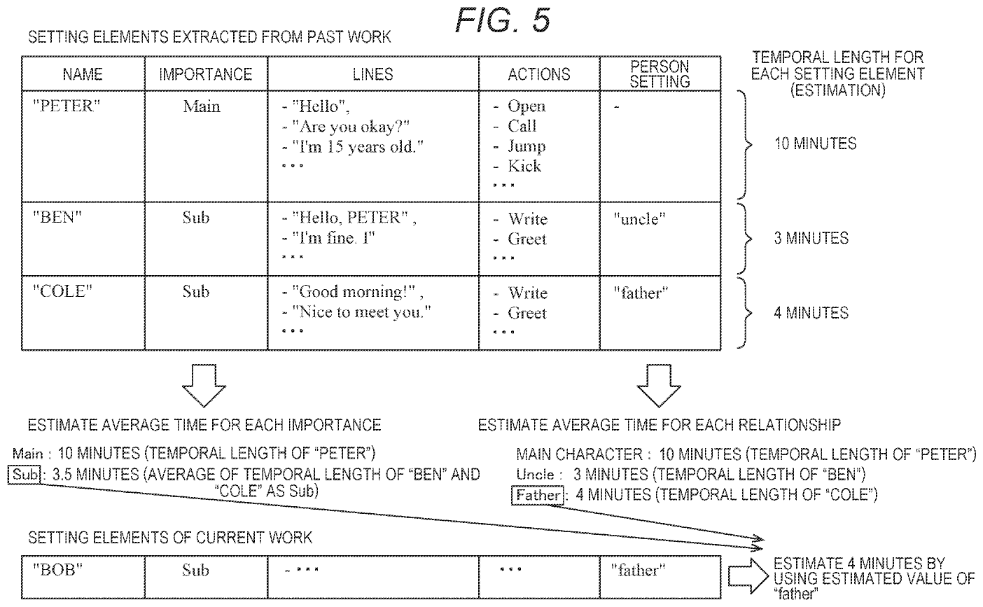

FIG. 5 is a diagram for explaining estimation of a temporal length for each setting element of the current work according to the first embodiment. The estimation unit 1221 first distributes the temporal length of the entire work to each person on the basis of the calculated average correction constant for each movie genre, the extracted list of lines of each person, and the action list of each person for the past work. For example, in the example illustrated in FIG. 5, it is estimated for all the characters that “PETER” has 10 minutes, “BEN” has 3 minutes, “COLE” has 4 minutes, and so on. Next, the estimation unit 1221 estimates the temporal length of each item of the setting element other than the lines and the actions on the basis of the temporal length of each person. Specifically, as illustrated in FIG. 5, the temporal length is estimated (averaged) for each “importance” or each “person setting”. Such estimation processing of the temporal length for each “importance” or each “person setting” can be performed on all past works managed by the information processing apparatus 1. Note that a database including a result of performing such estimation processing on a large number of past works may be prepared and used by the information processing apparatus 1. Furthermore, the information processing apparatus 1 may acquire and estimate past work information (scenario information, temporal length of video, and the like) from the Internet, and accumulate the results in the database. Note that such estimation processing is not limited to the characters, and can be similarly performed on other setting elements, that is, places, large props/props, and the like. In the case of these setting elements, since there are no lines or actions, the temporal length of each setting element can be estimated using the number of appearance scenes. Furthermore, the estimation processing described above can also be applied to machine learning by a recurrent neural network (RNN).

Then, the estimation unit 1221 estimates the temporal length of each setting element of the current work using the learning result, and calculates the sum of the estimated values of the setting elements as the estimated value of the temporal length of the current work. In the example illustrated in the lower part of FIG. 5, the temporal length of “BOB” which is the setting element of the current work is estimated. At this time, in a case where there is a plurality of items of setting elements that can be used (for example, “importance” and “person setting”), and different estimated values are candidates (3.5 minutes for “importance: Sub”, and 4 minutes for “person setting: father”), one of the items may be selected according to a predetermined rule. For example, the number of times the items of the same setting element are used in the past work may be calculated, and the item of the setting element having the smallest number of times may be used. In the example illustrated in the lower part of FIG. 5, for example, the element “father” has a smaller number of appearances in the past work than the element “importance: Sub” and “person setting: Father”, and thus, it is possible to select this estimated value of 4 minutes. This is because an item having a large number of appearances is highly likely to have a large variation.

Note that the estimation unit 1221 can appropriately switch the learning data of the past work used for the estimation processing. Since the scenarios of the past works are created by various producers, there are differences in the details of the style and description. For example, if a case of noise as described below occurs, there is a possibility that highly accurate estimation cannot be performed. As a case of noise, for example, a “case where extraction of a setting element is not successful in terms of a style” is assumed. For example, there is a case where the text is divided into a plurality of sentences and the subject is omitted (sentence example; “There is a desk, with monitors, and a chair. But apparently no one inside.”), a case where the object is omitted (sentence example; “JAY exits.” (“JAY exits the door.”), a case where it is described by a pronoun (sentence example; “There is a desk, with monitors, and a chair.”+“It is JAY's.”), or a case where it is modified at a structurally distant portion (sentence example; “There is a desk, with monitors, and a chair. . . . . . . . . The desk is JAY's.”). In addition, a case where the setting element is not written in the scenario even if the setting element can be appropriately extracted (information of the extracted setting element is less than expected) is also assumed. Therefore, in the present embodiment, the likelihood of the extraction result of the setting element may be calculated in units of works, and the learning data of the past works to be used may be switched on the basis of the likelihood. The calculation of the likelihood may be performed by the estimation unit 1221 or may be performed in advance by an external device.

Here, an example of likelihood calculation of a work will be described. For example, a portion corresponding to the “case of noise” described above is counted in the entire scenario body, and divided by the number of words in the entire scenario body to calculate a normalized result. Specifically, likelihoods corresponding to the degree of detail of the following style and description are calculated, and a result of multiplication is defined as a final likelihood of the work.

### (1) Likelihood According to Style: Addition Value of Following Items

The sentence is divided into a plurality of sentences and the subject is omitted→a portion where the subject is missing is counted by syntax analysis.
The object is omitted→a portion where the subject is missing is counted by syntax analysis.
It is described with a pronoun→a portion where the subject is missing is counted by syntax analysis.
It is modified in structurally distant portions→the number of times nouns with the same name appear in portions two or more sentences apart in the same paragraph is counted.

### (2) Likelihood According to Degree of Detail of Description: Following Addition Value

Coverage rate in assumption of information of extracted setting element→average of extraction rates of item information for each setting element

Then, the estimation unit 1221 can switch the learning data to be used with reference to the likelihood of the past work when estimating a predetermined value of the current work (for example, a temporal length when being imaged). Specifically, for example, the estimation unit 1221 can perform estimation with relatively high accuracy by calculating the likelihood of the input scenario being produced, comparing the calculated likelihood with the likelihood of the past work, and using learning data of the past work having close values. In a case of a producer who writes a scenario while relatively omitting subjects and objects, noise due to a difference in description amount and a difference in extraction accuracy can be reduced by comparing with a scenario of a past work in which subjects and objects are often omitted in the same manner.

Next, the comparison unit 1222 compares the estimated value with the target value (step S115), and determines whether or not the difference between the estimated value and the target value is greater than or equal to a specified value (step S121).

In a case where there is no difference equal to or larger than the specified value (step S121/No), the output information generation unit 122A generates a display screen displaying the estimated value (the estimated temporal length in a case where the current work is imaged) by the display screen generation unit 1224, and displays the generated display screen on the display unit by the output control unit 123A (step S121).

On the other hand, in a case where there is a difference equal to or larger than the specified value (step S121/Yes), the output information generation unit 122A causes the correction information generation unit 1223 to generate correction information of a setting element (determine a setting element to be proposed to be added or deleted) by using the information of the setting element of the past work (step S124). Note that it is possible to adjust how much the deviation causes the generation processing to be executed by changing the specified value (by the user). The correction information generation unit 1223 determines a setting element to be added if the estimated value is less than the target value, and determines a setting element to be deleted from among the setting elements of the current work if the estimated value exceeds the target value.

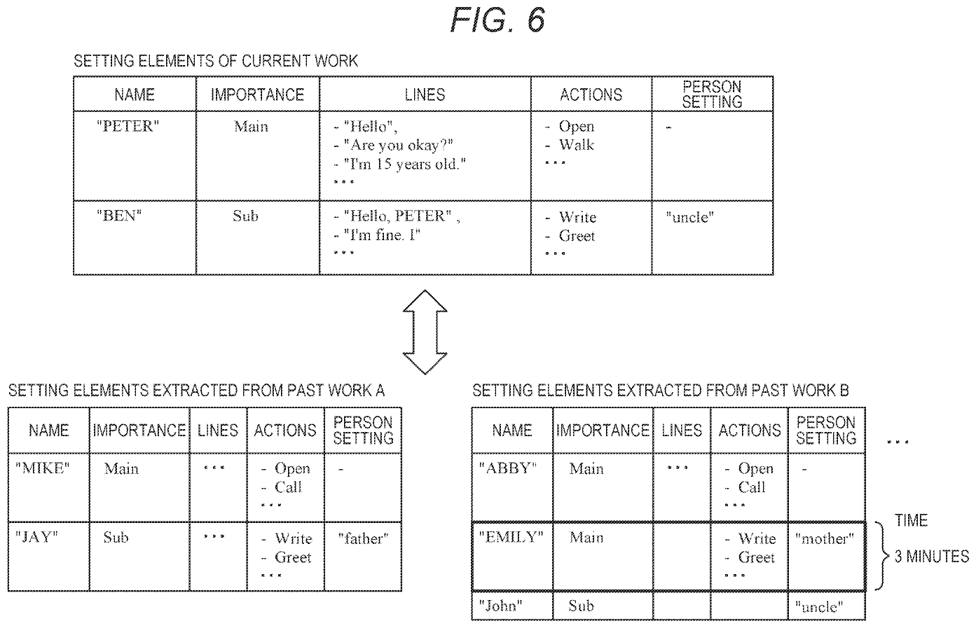

FIG. 6 is a diagram for explaining a case where a setting element to be added is selected from past works. The correction information generation unit 1223 utilizes the learning data of the past work used when the estimation processing by the estimation unit 1221 described above is performed, and selects the setting element matching the numerical value to be increased. That is, as illustrated in FIG. 6, the correction information generation unit 1223 selects a setting element of an estimated value that fills the difference with the target value from the estimated value (example; temporal length) for each setting element obtained by learning of past works. However, with this condition alone, a large number of setting elements become selection targets, and there is a possibility that a setting element overlapping with the setting element of the current work may be selected. Therefore, the correction information generation unit 1223 may determine a setting element appropriate to be added to the current work on the basis of the following scales (a) to (c).
(a) Similarity between current work and past works (preferentially select works whose contents are similar to the scenario being produced)
(b) Inverse of similarity between setting element of current work and setting element of past works (preferentially select setting element not similar to setting content being produced)
(c) Size of work's revenue (for example, box-office revenue) (preferential selection from popular past works)

The similarity between works may be, for example, a value obtained by calculating a distance between vectors using each setting element in the works as an element. In practice, the above three scales may be calculated, normalized, and a result obtained by multiplying the three scales may be adopted as an evaluation score, and may be output as a candidate for proposing addition in descending order of the evaluation score. The evaluation score is calculated for all the setting elements of the similar past work. Note that the weighting of each scale may be variable at the time of normalization, and the user may select the scale. As a result, the correction information generation unit 1223 can determine, as a candidate for an additional setting element, a setting element that is from a past work similar to the scenario being produced (for example, genres, person settings, stages, and the like are similar), does not overlap with the setting element of the current work, and is likely to be popular (likely to be profitable) as much as possible.

In the example illustrated in FIG. 6, in the scenario being produced, the past work B is similar to the past work A (because a common setting element of “person setting: uncle” exists in the past work B), and a setting element “EMILY” that is not similar to the information of the setting element of the current work (because a non-common “person setting: mother” is included) is selected from the past work B. In addition, the information of the temporal length “3 minutes” of the setting element “EMILY” is used to create a proposal sentence to be described later. In addition, an action of a setting element “EMILY” may also be included in the proposal content.

On the other hand, in a case where the estimated value based on the information on the setting element of the current work exceeds the target value and it is better to partially delete the setting element of the current work, the correction information generation unit 1223 may refer to the value (see FIG. 5) estimated for each setting element of the current work and select a setting element having an optimum value for eliminating the difference from the target value. Furthermore, in this case as well, since a case where there is a plurality of candidates is assumed, the correction information generation unit 1223 may determine a setting element suitable for deletion on the basis of the following scales (A) to (C).
(A) Similarity between current work and past works (preferentially select works whose contents are similar to the scenario being produced)
(B) Inverse of similarity between setting element of current work and setting element of past works (preferentially select setting element not similar to setting content being produced)
(C) Smallness of work's revenue (for example, box-office revenue) (preferentially select from setting elements same as (similar to) unpopular past works as deletion candidates)

The correction information generation unit 1223 calculates a value obtained by normalizing these and then multiplying them, and sequentially selects the value as a deletion candidate.

In the example described above, the characters are taken as an example of the selection of the setting element to be added/deleted, but the present embodiment is not limited thereto, and each addition/deletion candidate can be selected by performing similar processing on other setting elements such as a stage (period and place), large props/props, and the like.

In addition, in the calculation of the evaluation score for determining the priority order of the addition candidate/deletion candidate, the importance of the setting element may be taken into consideration. For example, a setting element having high importance may be prioritized as an addition candidate, and a setting element having low importance may be prioritized as a deletion candidate.

Furthermore, the correction information generation unit 1223 can switch the learning data of the past work used when determining the addition candidate/deletion candidate according to the likelihood, similarly to the case of the estimation processing. The calculation of the likelihood is as described above. In order to search for candidates in a wider range, the correction information generation unit 1223 may lower the likelihood threshold and determine an addition candidate/deletion candidate using learning data of more past works.

Subsequently, the correction information generation unit 1223 generates a sentence for proposing addition or deletion of a setting element (step S127). For example, the correction information generation unit 1223 may generate the selected addition candidate/deletion candidate by applying the selected addition candidate/deletion candidate to a predetermined sentence template.

Next, the control unit 12A controls the output control unit 123A to display, on the display unit, the display screen that is generated by the display screen generation unit 1224 and proposes addition or deletion of a setting element (step S130). FIG. 7 is a diagram illustrating a display example of a setting element change proposal according to the first embodiment. A screen 410 illustrated in FIG. 7 is a screen displayed on the display unit of the information processing apparatus 1. The screen 410 is in a state where the person correlation tab 411 is selected as the input of the setting element, and the person correlation input screen 412 is displayed. A method of inputting the person correlation is not particularly limited, but for example, the user may create a correlation diagram by inputting text or selecting an icon, or may select a template of a correlation diagram prepared in advance and correct the template. Furthermore, on the input screen 412, a target value (for example, a temporal length) can also be input. On the right side of the display screen 410, a screen 413 indicating the change proposal is displayed. The screen 413 may be a card type UI. Such a change proposal may be displayed immediately each time the person correlation on the input screen 412 is changed. Whether or not to adopt the proposal is determined by the user. This is because it is considered that human judgment is preferable in consideration of user's (producer's) preferences and consistency of the entire final scenario. In addition, a plurality of proposed modification proposals may be provided. These are displayed one by one in the card type UI, and buttons for determining whether or not to adopt each are arranged. The user can arbitrarily select one or more proposals (card type UI). The control unit 12A reflects the adopted proposal on the person correlation of the input screen 412, and performs estimation processing (of the temporal length of the current work (during input)) again.

Next, in a case where the user adopts the proposal (step S133/Yes), the display screen generation unit 1224 searches for a range that affects the scenario by adopting the proposal (step S136), and displays the range that affects the scenario (step S139). This is because there is a case where consistency with the content of the scenario cannot be obtained if the setting element is changed in a case where the scenario being produced is input. As described above, association between the setting elements and the words of the scenario body is performed by the tagging processing unit 124, and the display screen generation unit 1224 performs the body searching processing with reference to the processing result and specifies a range affected by adoption of the proposal.

The tagging processing may be performed each time the scenario body is updated by editing. FIG. 8 is a diagram for explaining the tagging processing according to the first embodiment. As illustrated in FIG. 8, for example, the word (here, “Suzuki” and “boss”) existing in the information of the extracted one setting element is extracted from the scenario body and replaced with a predetermined tag name (here, “@boss”). As a result, the scenario body and the setting element are associated with each other and even in a case where the word “boss” simply appears in another portion of the scenario body, it can be determined that it is “Suzuki”.

The display screen generation unit 1224 searches for a tag of a setting element for which deletion has been adopted for such a tagged scenario body, extracts a sentence or a paragraph in which the tag exists, and generates a screen to be presented to the user as a range to be affected. FIG. 9 is a diagram illustrating a screen example of displaying a range that affects a scenario by deletion of a setting element according to the first embodiment. As illustrated in FIG. 9, the screen 420 displays a range 422 that affects the scenario by deletion of the setting element (here, the character “boss”) in a state where the tab 421 of the scenario is selected. The range 422 affecting the scenario is highlighted, for example. Note that whether the range 422 affecting the scenario is set in units of sentences or in units of paragraphs can be changed by the user by setting. Furthermore, the screen 423 indicating a deletion proposal for the influence on the scenario can be displayed by the card type UI as illustrated in FIG. 9. In a case where the whole range 422 that affects the scenario is to be deleted, the user selects the “delete” button on the screen 423.

Note that, as described above, a case is also assumed where the proposal is adopted, but it is desired to undo it later. In the present embodiment, the suggested content or the content changed by the user according to the suggestion may be stored in the setting element change history DB 143 as a history, and the change history may be listed in the card type UI as illustrated in FIG. 10. FIG. 10 is a diagram illustrating a screen example of displaying a history of changes made according to the proposal according to the first embodiment. In a case where the user desires to undo the change regarding each setting element, it is possible to return the scenario body to the state before the change by selecting the “rollback” button.

On the other hand, in a case where the user does not adopt the proposal (step S133/No), the output information generation unit 122A stores information regarding the proposal in the storage unit 14 (step S142).

### 3-3. Display Screen Example

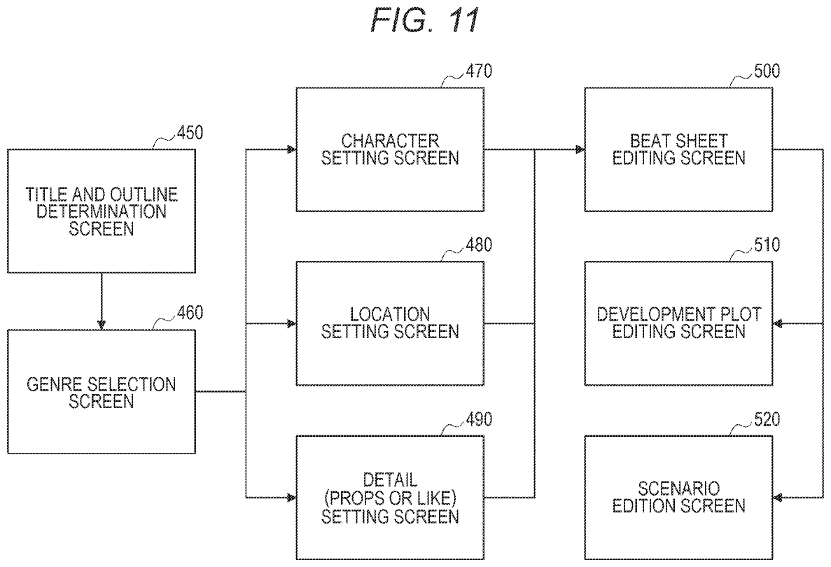

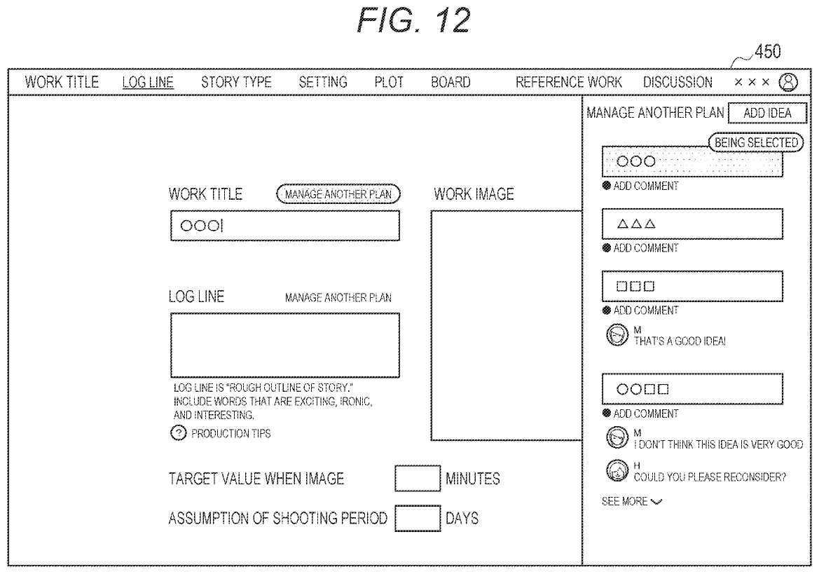

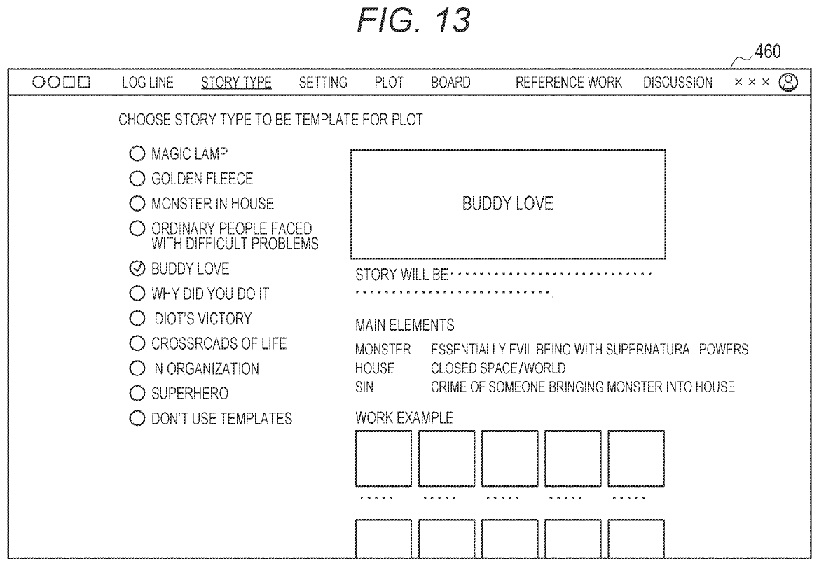

FIG. 11 is a diagram for explaining an example of screen transition in the scenario production support according to the first embodiment. As illustrated in FIG. 11, for example, first, the title and outline of the work to be produced are input on the screen 450, and then genre selection is performed on the screen 460. Here, an example of the screen 450 (title and outline determination screen) is illustrated in FIG. 12. As illustrated in FIG. 12, on the screen 450, input of a title of a work, an image (image), a log line (a sentence in which the content of a story is summarized in one line), a target temporal length at the time of imaging, an assumption of a shooting period, and the like is performed. Note that a screen for managing another plan may be provided on a part of the screen 450. Furthermore, on the screen for managing another plan, it is also possible to display messages from other users such as team members or to give ideas to other users. In addition, FIG. 13 illustrates an example of the screen 460 (genre selection screen). As illustrated in FIG. 13, on the screen 460, the type (genre) of the story is selected from the template.

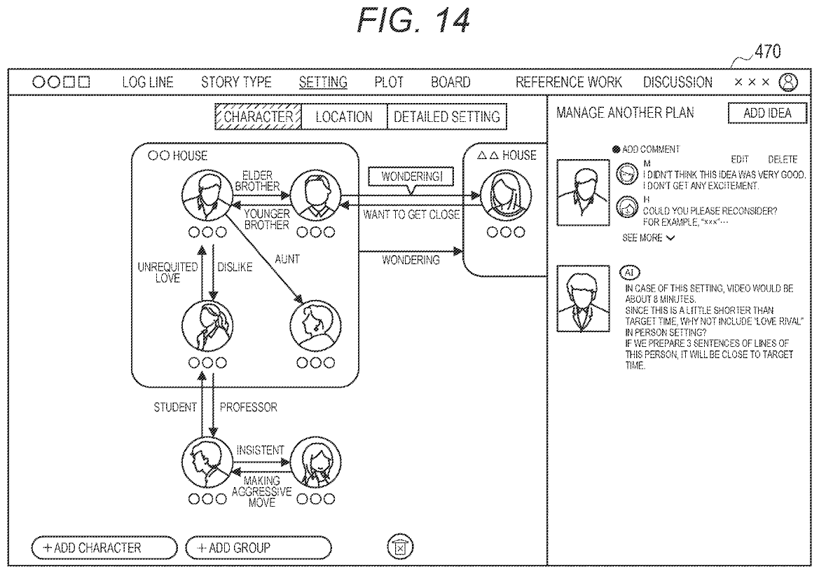

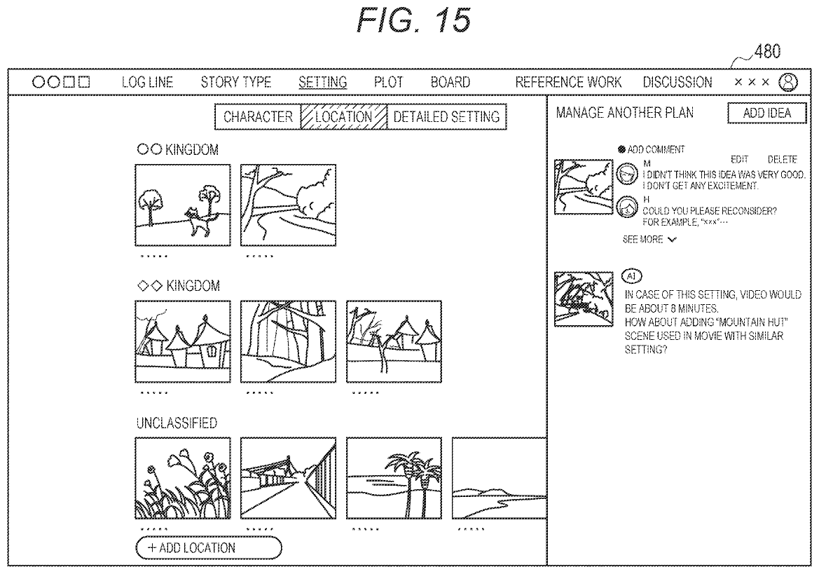

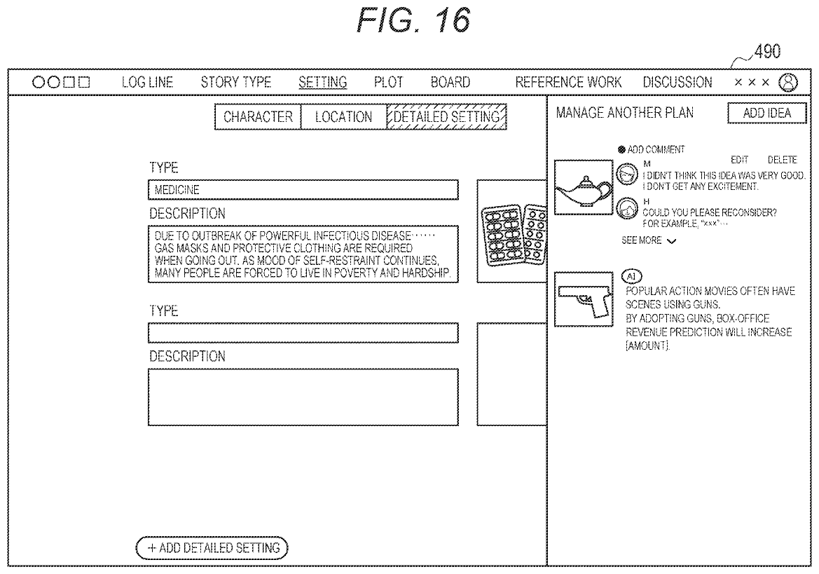

Next, as illustrated in FIG. 11, settings of the entire work are input on the respective screens of the setting screen 470 for characters, the setting screen 480 for location, and the setting screen 490 for details (large props, props, and the like). Note that, on each setting screen, a proposal for addition/deletion of a setting element can be made as appropriate using information (learning data) of the setting element extracted from the information of the scenario of the past work. Here, FIG. 14 illustrates an example of the setting screen 470 for characters, FIG. 15 illustrates an example of the setting screen 480 for locations, and FIG. 16 illustrates an example of the setting screen 490 for details (large props, props, and the like). As illustrated in each figure, a proposal for addition/deletion of a setting element is displayed by an icon of “AI” on each setting screen. When the user adds/deletes the setting element according to the proposal, the content of the proposal is updated.

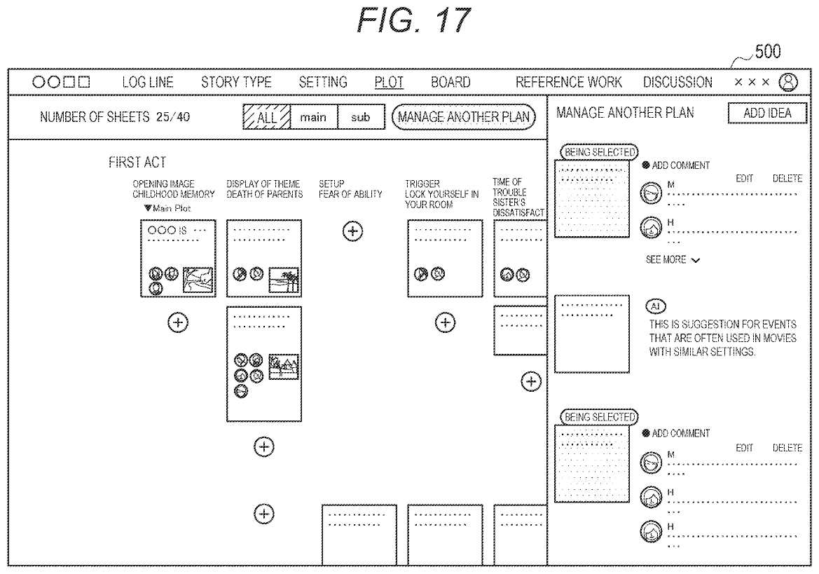

When the settings of the entire work are input, an action (event) in each scene is edited on the beat sheet editing screen 500 as illustrated in FIG. 11. Here, addition/deletion of the setting element information (here, an action) can be proposed as appropriate using the setting element information (learning data) extracted from the past work scenario information. FIG. 17 is a diagram illustrating an example of the beat sheet editing screen 500. As illustrated in FIG. 17, on the beat sheet editing screen 500, for example, actions (events) are arranged in the order of scene development for each act constituting a story. Note that a screen for managing another plan may be provided in a part of the screen 500. On the screen for managing another plan, it is also possible to display messages from other users such as team members or to give ideas to other users. In addition, on the screen for managing another plan, a proposal for addition/deletion of a setting element is also displayed with an icon of “AI”.

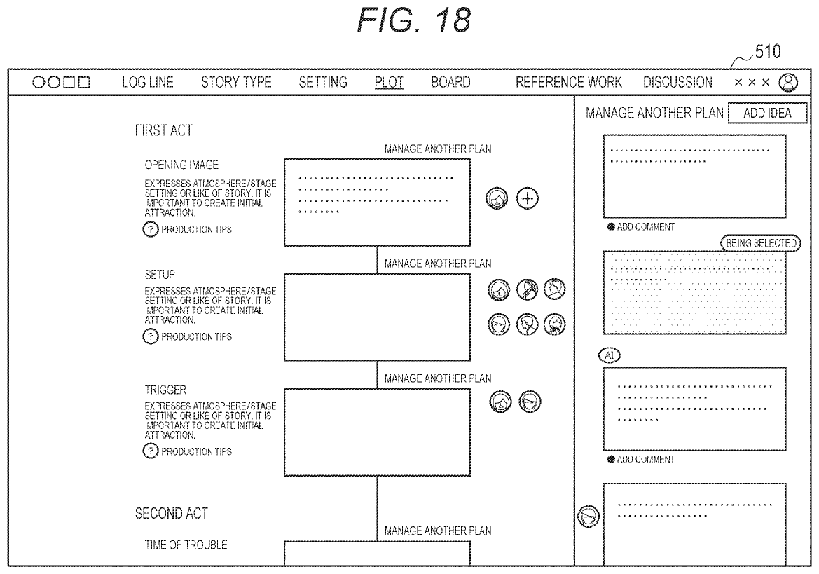

Next, as illustrated in FIG. 11, the specific content of the plot is determined on the development plot editing screen 510. FIG. 18 is a diagram illustrating an example of the development plot editing screen 510. As illustrated in FIG. 18, on the development plot editing screen 510, plots are arranged in the order of scene development. Note that a screen for managing another plan may be provided in a part of the screen 510. On the screen for managing another plan, it is also possible to display messages from other users such as team members or to give ideas to other users. In addition, on the screen for managing another plan, a proposal for addition/deletion of a setting element is also displayed with an icon of “AI”.

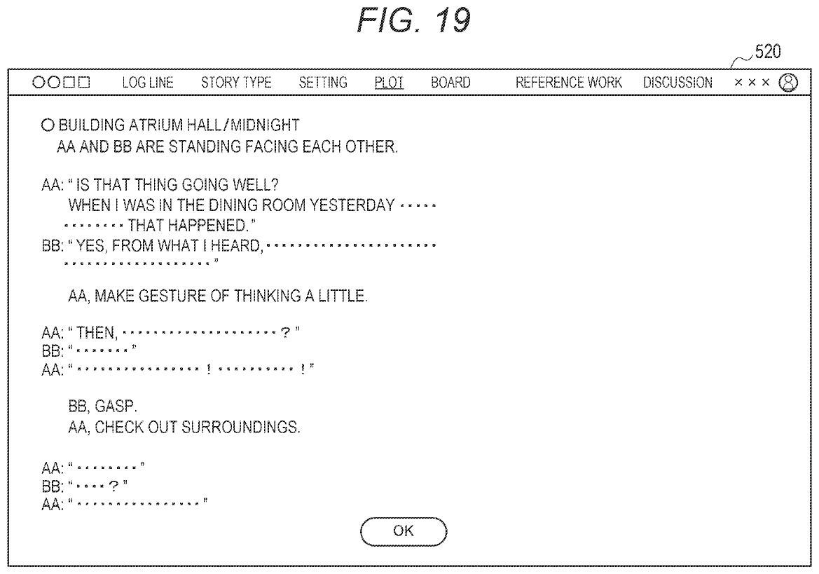

Then, the user finally produces a scenario on the scenario editing screen 520 on the basis of the above content. FIG. 19 illustrates an example of the scenario editing screen 520. As illustrated in FIG. 19, on the scenario editing screen 520, a scenario body such as a scene heading, a stage direction, and a line is input.

The screen transition example in the case of the flow of performing scenario production after determining the setting and development plot of the entire work and the proposal of the setting element in each screen have been described above. Note that the above-described screen transition is an example, and the present embodiment is not limited thereto.

For example, the information processing apparatus 1 may extract a setting element from a scenario being produced input on the scenario editing screen 520, and appropriately propose a change of the setting element according to the target value.

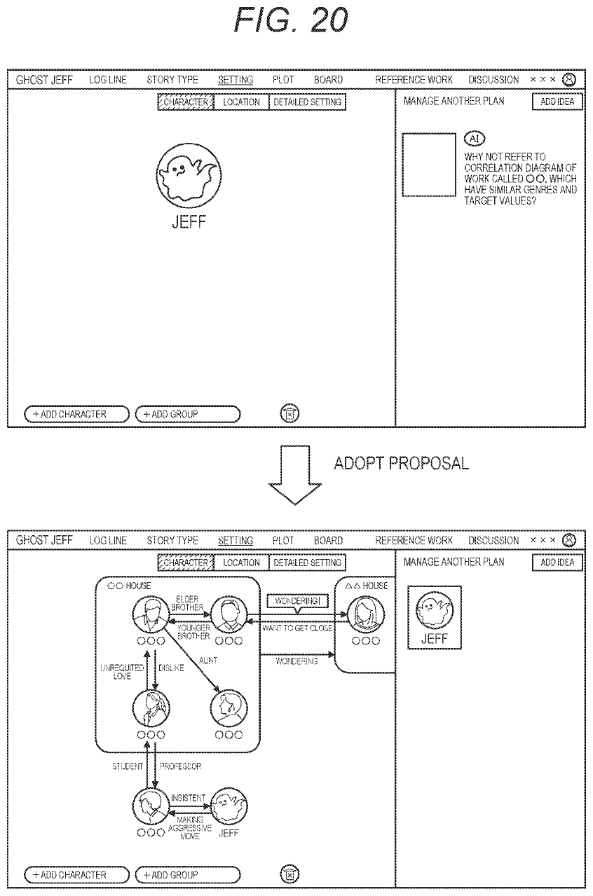

In addition, in the screen transition illustrated in FIG. 11, since there are few setting elements input on the first setting screen such as the setting screen 470 for characters, there is a high possibility that the content of the additional proposal does not match the content being produced. Therefore, in the present embodiment, in a case where the number of input setting elements is equal to or less than a certain number, or in a case where the difference from the target value is larger than the threshold, the additional proposal element is presented only as a reference. Note that, in the screen transition illustrated in FIG. 11, there is no case where there is no setting element since the title and the genre are set as the required input items first and the word vector is set as the initial setting element. Furthermore, in the case of being proposed as a reference, a large number of setting elements may be proposed collectively as one cluster instead of presenting additional setting elements one by one. FIG. 20 is a diagram for explaining a case where a person correlation according to the first embodiment is proposed in units of correlation diagrams as a reference. As illustrated in the upper part of FIG. 20, in a case where, for example, only one setting element is input on the setting screen for the characters, the information processing apparatus 1 makes a proposal in units of correlation diagrams. In a case where the user adopts the proposal, as illustrated in the lower part of FIG. 20, the entire setting element being input is replaced with the proposed correlation diagram. In addition, the setting element that is being input is stored as another plan.

### 3-4. Application Example

The estimation by the estimation unit 1221 is not limited to the estimation of the temporal length at the time of imaging, and for example, the shooting cost can be estimated. The shooting cost may be time required for shooting or CG production, or may be expense based on time and labor cost. In general, the shooting cost increases as the number of lines and actions of characters, locations, and persons increases. The operation processing of implementing the proposal of the setting element (generation of the correction information of the setting element such as addition/deletion) based on the shooting cost is performed similarly to the operation processing illustrated in FIG. 3. As a difference, in step 3103, “shooting cost” is input as the target value. In addition, in step 3112, the estimation unit 1221 estimates the shooting cost at the time of imaging the current work. Specifically, the estimation is performed with reference to the learning data of the past work. Specifically, by learning using the information of the setting elements extracted from the scenario of the past work and the data of the shooting cost (shooting time) of each scene obtained as the knowledge of the past work, estimation of how much each setting element affects the shooting cost is performed. Then, in step S115, the target value and the estimated value are compared, and in step S118, in a case where the difference between the estimated shooting cost of the current work and the target value is greater than or equal to the specified value, a setting element to be added or deleted is determined in step S124. For example, in a case where the estimated shooting cost of the current work is larger than the target value, a proposal for deleting the setting element (suggestions to reduce shooting time, such as deletion of characters and locations) is made. Note that it is expected that the shooting expense will be reduced as the shooting time is reduced.

Furthermore, the estimation unit 1221 can also estimate various values by using various information of past works. For example, the estimation unit 1221 can also estimate the box-office revenue on the basis of the setting element. The estimation unit 1221 performs learning by using the information of the setting elements extracted from the scenario of the past work and the data of the box-office revenue obtained as the knowledge of the past work, thereby estimating how much each of the setting elements affects the box-office revenue. In the case of the box-office revenue, it is considered that each line or action has little influence on the box-office revenue, and the box-office revenue prediction for each setting element is calculated without performing the provisional calculation processing and the correction constant processing as illustrated in FIG. 4.

Furthermore, the estimation unit 1221 can also perform popularity estimation processing using positive/negative determination of word-of-mouth review of past works, time-series data of how emotions of audience and characters move when viewing a video work called an emotion curve, and the like.

### 4. Second Embodiment

In the second exemplary embodiment, as support of scenario production, information for generating a simulation video (visualizing the scenario) (so-called pre visualization to be imaged using a simple CG) is generated from the information of the scenario. In addition, in the second embodiment, it is also possible to distinguish and visualize components that are automatically generated and components that can be corrected and operated. In general, a process of producing a video such as a movie or a commercial is established by a procedure of “planning→shooting→editing→finishing”, and a pre visualization (simulation video) can be created between planning and shooting. In the present embodiment, components such as a location, a character, and large props/props (synonymous with “setting element” in the first embodiment) and detailed information (in the present embodiment, referred to as attribute information) such as movements thereof are extracted from a scenario (script), and pre visualization is automatically generated (scenario is visualized). Hereinafter, the configuration and operation processing of the second embodiment will be sequentially described.

### 4-1. Configuration Example

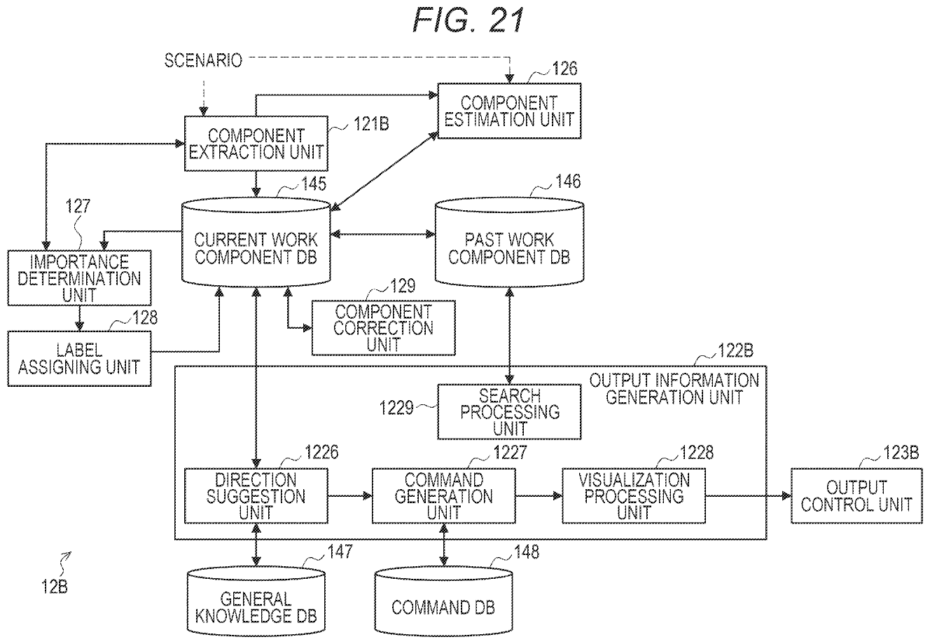

FIG. 21 is a block diagram illustrating a configuration example of a control unit 12B according to the second embodiment. As illustrated in FIG. 21, the control unit 12B includes a component extraction unit 121B, an output information generation unit 122B, an output control unit 123B, a component estimation unit 126, an importance determination unit 127, and a label assigning unit 128. In addition, the output information generation unit 122B functions as a direction suggestion unit 1226, a command generation unit 1227, and a visualization processing unit 1228. Note that, in the example illustrated in FIG. 21, for the sake of explanation, the current work component DB 145, the past work component DB 146, the general knowledge DB 147, and the command DB 148, which are databases (DBs) included in the storage unit 14, are also illustrated.

### (Component Extraction Unit 121B)

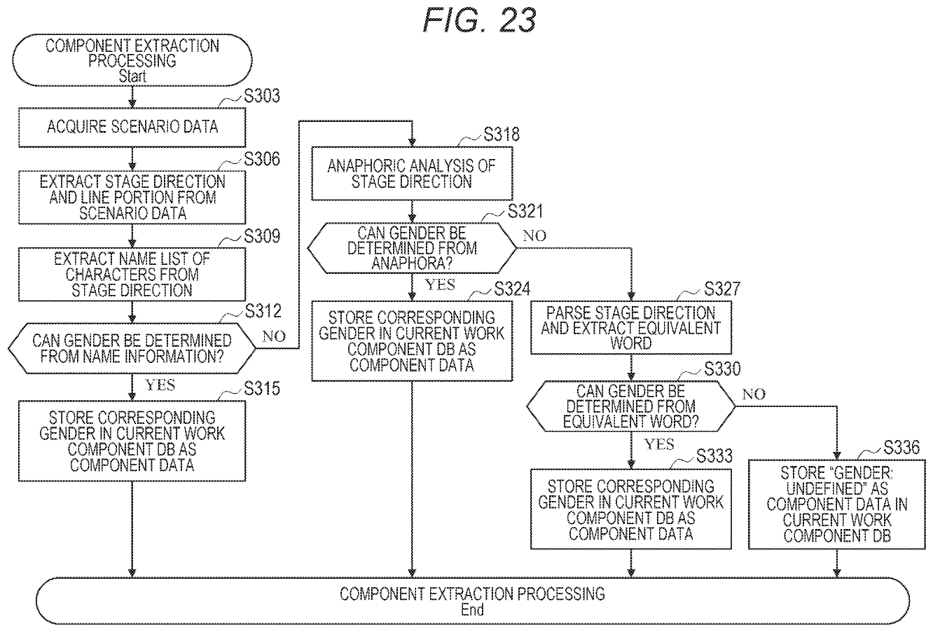

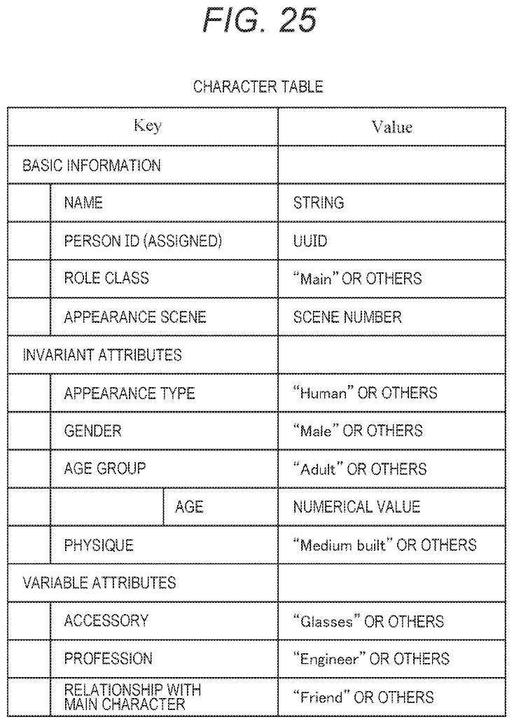

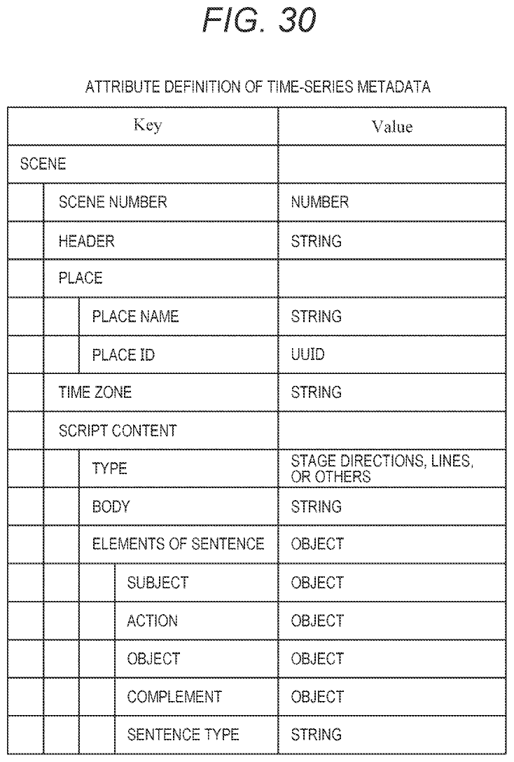

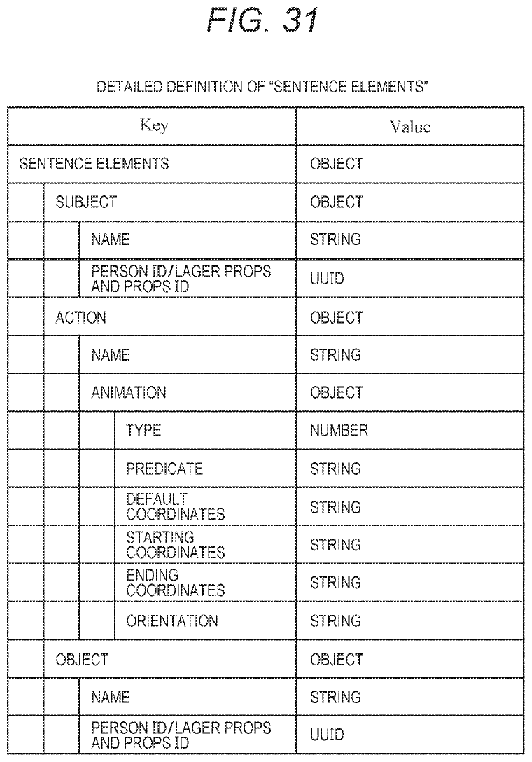

The component extraction unit 121B extracts a component for visualization from the input information (text data) on the scenario being produced, and stores the extracted component information in the current work component DB 145. The component extraction unit 121B performs natural language processing such as morphological analysis, syntax analysis, and anaphoric analysis on the information (text data) of the scenario, and extracts a component to be visualized. Note that the control unit 12B shapes the input scenario information for analysis and passes the information to the component extraction unit 121B in a text file. First, the component extraction unit 121B extracts mainly “lines” of characters, “stage direction” that is a sentence for instructing an action or a direction, and “scene heading” that explains a place and a time zone. Then, the component extraction unit 121B extracts, from these descriptions, attribute information of a component (entire metadata) that does not depend on a scene, such as a character, a location, and large props/props, in a format according to a predetermined rule (see FIGS. 25 to 27). Furthermore, the component extraction unit 121B extracts attribute information of a component (time-series metadata) depending on the scene, such as a movement of a character or a change in large props/props, from “stage direction” or “scene heading” (see FIGS. 30 and 31). Details of the component extraction processing will be described later with reference to FIG. 23.

The component information (entire metadata, time-series metadata) extracted by the component extraction unit 121B is stored in the current work component DB 145. Furthermore, after various processes according to the present embodiment are completed, or the like, finally, only “entire metadata” can be transferred from the current work component DB 145 to the past work component DB 146 by the control unit 12B. The current work component DB 145 stores the input text-specific component information, and the input text-specific component information can be appropriately corrected by the user. Furthermore, the past work component DB 146 stores information on components of the past work that has already been analyzed.

### (Component Estimation Unit 126)

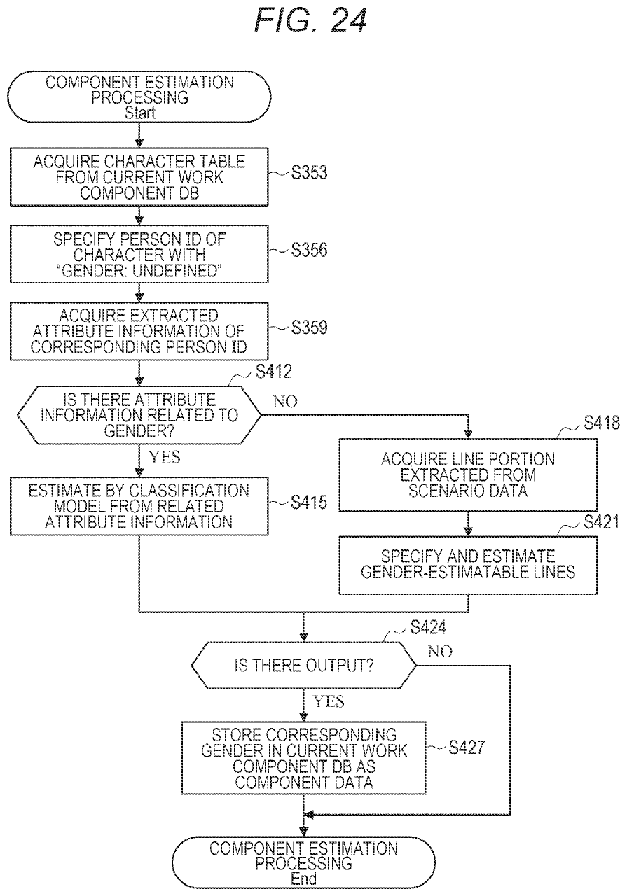

The component estimation unit 126 estimates attribute information in a format following a predetermined rule in order to complement information (attribute information) of a component that cannot be extracted by the component extraction unit 121B. The component estimation unit 126 may estimate information of an insufficient portion from the information of the scenario or the information of the extracted component using the machine learning model. The estimated attribute information is stored in the current work component DB 145. Details of the component estimation processing will be described later with reference to FIG. 24.

### (Importance Determination Unit 127 and Label Assigning Unit 128)

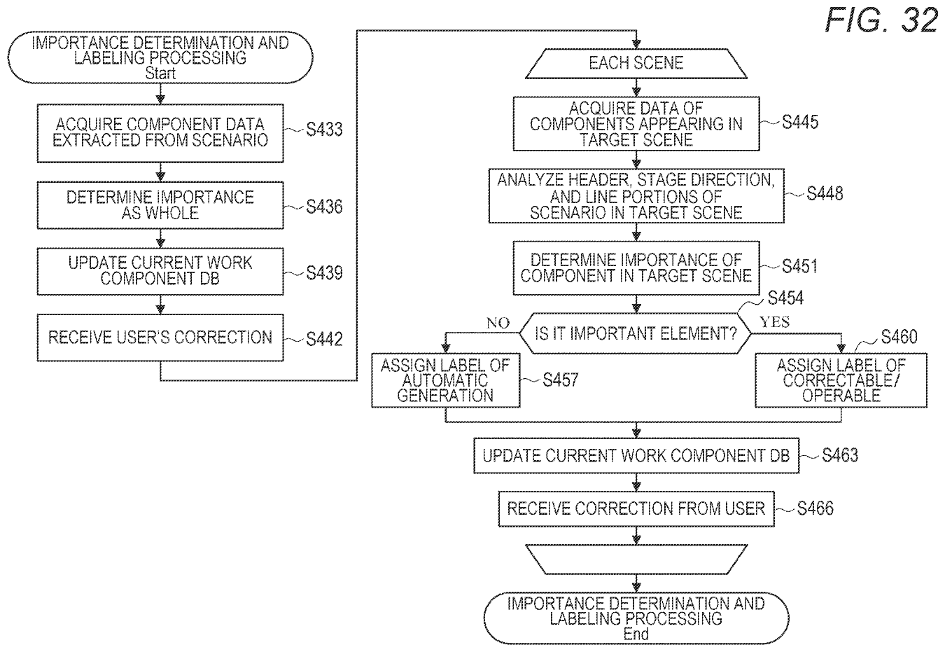

The importance determination unit 127 determines the importance of the extracted or estimated component in the story. The determination of the importance may be performed at the same time as the extraction processing by the component extraction unit 121B, or may be performed after the extraction processing and the estimation processing are completed. Specifically, the importance determination unit 127 determines the importance of the entire scenario (work) and the importance of each scene for each component. The determination of the importance is calculated (determined) on the basis of the number of appearances of the components, the fineness of depicting, the number of conversations, and the like. Details of the component importance determination processing will be described later with reference to FIG. 32.

The label assigning unit 128 assigns an automatic/manual (user can correct and operate) label to each component according to the determination result by the importance determination unit 127. The label assigning unit 128 labels a component (that is, “important element”) having an importance higher than a threshold (or determined to be important) with a “manual” (user can correct and operate) label such that the user can arbitrarily correct and operate the component when the scenario is visualized. In the visualization processing unit 1228 to be described later, when visualizing the component labeled with “manual (user can correct and operate)”, visualization is performed by a method that enables user's correction and operation. As an example, it is assumed that 3DCG created in advance is used. Furthermore, the label assigning unit 128 labels a component having an importance lower than a threshold (or determined to be not important) with an “automatic” label assuming that a user does not perform correction/operation. In the visualization processing unit 1228 to be described later, when visualizing a component labeled with “automatic”, an image or a video is automatically generated from a text (attribute information of the component) using, for example, a learned model. As an example, it is assumed that the attribute information of the location serving as the background of each scene at the time of imaging is automatically generated, and the characters and the large props/props displayed in the foreground in the video are visualized by a method (3DCG) that facilitates user's correction and operation.

### (Component Correction Unit 129)

The component correction unit 129 performs a process of appropriately correcting (updating) the component information stored in the current work component DB 145 according to the operation input by the user. For example, the user can add or correct attribute information of a component, correct the importance, replace an assigned label, and the like from the editing screen of each component.

### (Direction Suggestion Unit 1226)

On the basis of the extraction/estimation (further labeled) components, the direction suggestion unit 1226 performs a process of suggesting a direction content at the time of imaging and writing out an instruction content to command generation unit 1227 in a text file.

Specifically, first, the direction suggestion unit 1226 determines a component to be automatically generated and a component to be visualized so that a user can correct and operate the component according to a label given to the component. Next, the direction suggestion unit 1226 suggests direction of audio, lighting, camerawork, and the like for each scene by also utilizing the information on the components, the data of the past works, and the importance of each component.

The audio is obtained from an analysis result of scenario information by the component extraction unit 121B or the component estimation unit 126. Examples of the audio include living sounds, environmental sounds, animal barks, and the like. The presence or absence and intensity of the sound are estimated mainly by combining the components of the location, the large props/props, and the verbs or modifiers of the components. For example, since both “the intercom rings” and “the bell rings” generate sounds but have different tones, the direction suggestion unit 1226 searches the general knowledge DB 147 or the like for sound source files suitable for both sounds and suggests the sound source files. Furthermore, in the case of the description “heavy rain”, the direction suggestion unit 1226 puts the modification level into a numerical value, and suggests a sound of rain according to the intensity. The lighting is proposed together with location information (attribute information of the component “location”) which is an analysis result of information of the scenario, information of large props/props related to the lighting, and other directions (audio or camerawork). It is assumed that the camerawork adopts data of a scenario (script) in a case where there is a direct instruction, such as “over the shoulder (OST)” which refers to a “shot over the shoulder” used when shooting characters. On the other hand, in a case where there is no designation on the scenario, the direction suggestion unit 1226 suggests the screen configuration, the movement of the angle camera, and the like in consideration of the viewpoints of the characters for each scene, the importance of the components, and the like.

The direction content (text-based) to be proposed is presented from the display unit to the user by the output control unit 123B, and is appropriately corrected by the user. The direction content is proposed for each scene, and is examined including reference to the past work, consistency of the entire scenario, and the like.

Note that the general knowledge DB 147 stores various knowledge data such as a person's physique and clothes, a tool size and color, a motion speed, and a sound source file. Furthermore, the general knowledge DB 147 may also store data (for example, association data of a name and a nickname (such as ANDREA and ANDY)) used for extraction by the component extraction unit 121B and estimation by the component estimation unit 126, and may be appropriately referred to in extraction and estimation processing.

### (Command Generation Unit 1227)

The command generation unit 1227 has a function of converting information of components and text-based information such as instruction content (direction content) created in the direction suggestion unit 1226 into a command for visualization that can be read by the visualization engine (processing in the visualization processing unit 1228 becomes possible). In the direction suggestion unit 1226 described above, the direction content for each scene based on the component is written out as text in a predetermined data format. Therefore, it is necessary to convert the contents into a predetermined command so that the contents can be read and visualized by the visualization engine (visualization processing unit 1228). Note that the generated command (converted data) and complement information at the time of conversion are stored in the command DB 148. The complementary information at the time of conversion is information added to a command in order to issue a more detailed instruction to the visualization processing unit 1228. For example, when the predicate of the action of the time-series metadata (see FIG. 30) which is one of the components, the object “go to the west”, and the default coordinates of the subject are included in the instruction content, it is assumed that the command generation unit 1227 converts the action into a command to which the content “move” is added as the type at the time of visualization, or converts the action into a command in which abstract expression or movement coordinates or directions not written in the language information are embodied.

### (Visualization Processing Unit 1228)

The visualization processing unit 1228 is a visualization engine that generates a simulation video of the scenario, that is, performs scenario visualization processing. Specifically, the visualization processing unit 1228 reads the command output from the command generation unit 1227 and executes the visualization processing. Specifically, the visualization processing unit 1228 searches for the 3DCG that can be corrected and operated by the user and automatically generates other components, and visualizes the “components for visualization” after aligning the “components for visualization”. The 3DCG that can be corrected and operated can be created and prepared in advance. Furthermore, the 3DCG is assumed to be a simple CG for a simulation video. In the automatic generation, the visualization processing unit 1228 may input the attribute information of the component to the generation model (learned model) and perform output centered on 2D/3D. Furthermore, in the case of a movie scenario, the visualization processing unit 1228 visualizes the searched 3DCG and the automatically generated image for each scene. The user can correct and operate the appearance, position, and the like of the correctable/operable component (3DCG) from the input unit 11.

### (Search Processing Unit 1229)

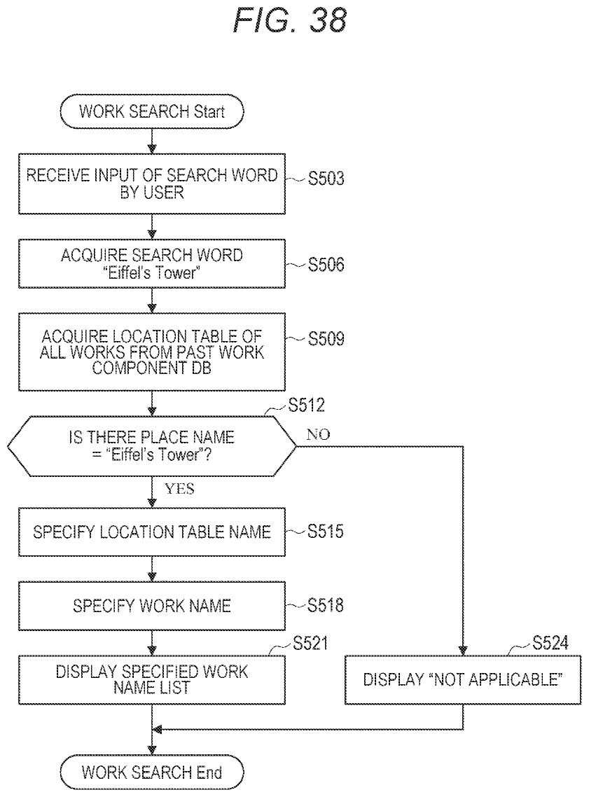

The search processing unit 1229 performs processing of searching the past work component DB 146 for predetermined information on the basis of the keyword input by the user. The search result is displayed on the display unit by the output control unit 123B. Furthermore, the search result may be used for calculation of shooting expense, calculation of CG production expense, and the like. Details will be described later with reference to FIGS. 38 to 41.

### (Output Control Unit 123B)

The output control unit 123B performs control to display the information generated by the output information generation unit 122B (for example, a simulation video imaged using a simple CG) on the display unit (an example of the output unit 13).

The configuration example of the control unit 12B according to the second embodiment has been described above. Note that the configuration illustrated in FIG. 21 is an example, and the present embodiment is not limited thereto. For example, all the configurations illustrated in FIG. 21 may not necessarily be included.

### 4-2. Operation Processing

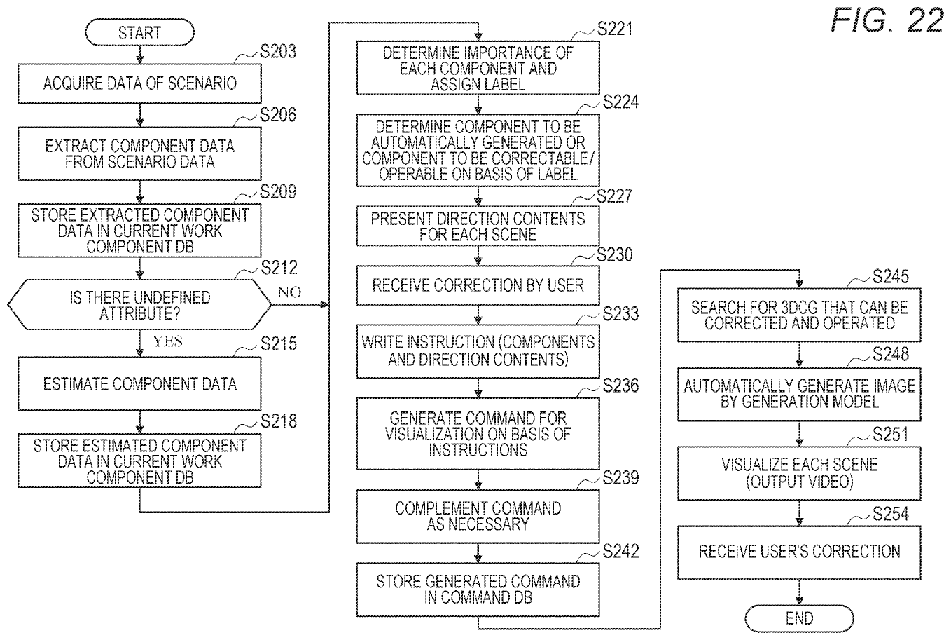

FIG. 22 is a flowchart illustrating an example of an overall flow of operation processing according to the second embodiment.

As illustrated in FIG. 22, first, the component extraction unit 121B acquires data of a scenario (current work) (step S203). For example, the scenario body (text data) may be input in the input unit 11.

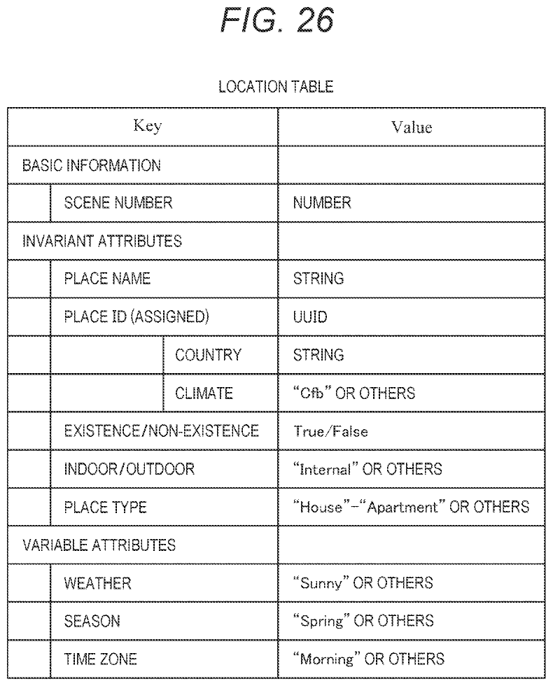

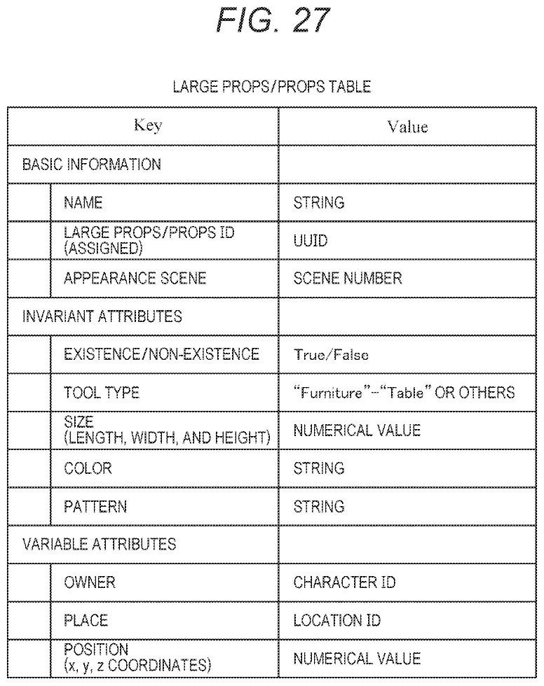

Next, the component extraction unit 121B extracts component data from the scenario data (step S206), and stores the extracted component data in the current work component DB 145 (step S209). Here, FIGS. 25 to 27 illustrate examples of attribute definitions in the information of each component. FIG. 25 is a diagram illustrating an example of a character table, FIG. 26 is a diagram illustrating an example of a location table, and FIG. 27 is a diagram illustrating an example of a large props/props table. Data of each component is extracted by the component extraction unit 121B from the scenario data, and attribute information is filled (attribute is defined).

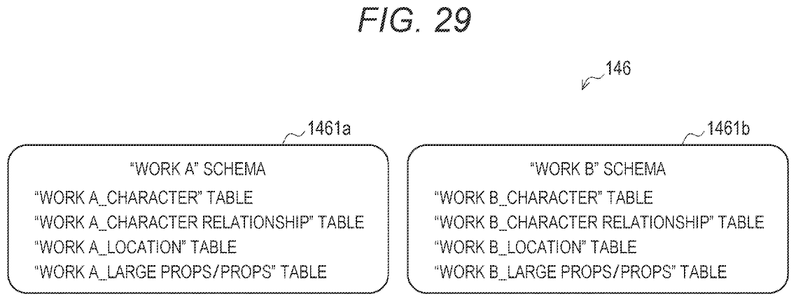

Note that the universally unique identifier (UUID) is an identifier for unique identification. In the extraction processing, the component extraction unit 121B also performs the same-element determination, and assigns an identifier that can be uniquely discriminated to the components such as the characters, the locations, and the large props/props. The same-element determination can be performed by natural language processing (syntax analysis or the like) on the information of the scenario. At this time, for example, when the same characters are extracted as different components due to different names, it is possible to indicate (associate) the same person by using the UUID. Furthermore, attribute information such as “name” and “person ID” in FIG. 25, “scene number” in FIG. 26, and “name” and “large props/props” in FIG. 27 is a key that uniquely manages data in extraction processing and estimation processing. For example, regarding characters and large props/props, at the time of extraction, the characters and the props may be managed by names, and at the time of estimation, the characters and the props may be managed by IDs. Furthermore, each component illustrated in FIGS. 25 to 27 corresponds to the entire metadata, and is finally stored in the past work component DB 146. That is, the information on each component stored in the past work component DB 146 is also formed by a table as illustrated in FIGS. 25 to 27. Note that a specific data configuration example of the past work component DB 146 will be described later with reference to FIG. 29.

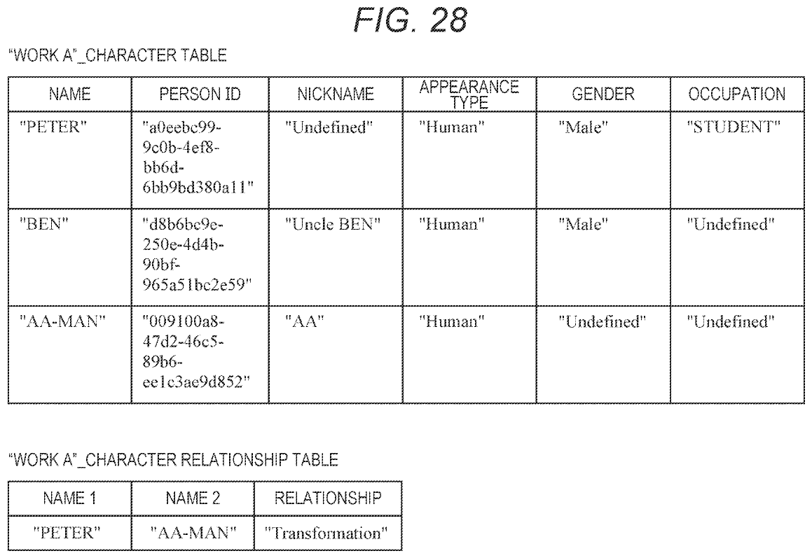

Here, the same-element determination will be described with reference to FIG. 28. As illustrated in the upper part of FIG. 28, for example, in the character table (component “data of characters”) of the work A, characters having different names are determined as different elements. However, it is obtained by analyzing the information of the scenario (or correction by user, addition) that the name “AA-MAN” is the name after the transformation of the name “PETER”. In this case, the relationship table of the characters as illustrated in the lower part of FIG. 28 is generated and stored in the current work component DB 145. Furthermore, the component extraction unit 121B determines that an element of the name “PETER” and an element of the name “AA-MAN” are the same person, and assigns the same UUID, thereby making association.

The components such as the characters, the locations, and the large props/props described above are the entire metadata independent of the scene. The component extraction unit 121B according to the present embodiment also extracts time-series metadata depending on a scene as a component. The time-series metadata is an element related to the time series (for example, content written in “stage direction” which is a sentence for instructing an action or performance). FIG. 30 is a diagram illustrating an example of attribute definition of the time-series metadata (component). Furthermore, FIG. 31 is a diagram illustrating an example of a detailed definition of “sentence elements” included in the time-series metadata. The component extraction unit 121B extracts the time-series metadata as illustrated in FIGS. 30 and 31 from the scenario information and stores the extracted time-series metadata in the current work component DB 145. The entire metadata and the time-series metadata are associated using a scene number or a UUID.

Next, in a case where there is an undefined attribute in the component data (step S212/Yes), the component estimation unit 126 estimates the component data (attribute information) (step S215), and stores the estimated component data in the current work component DB 145 (step S218). The case where there is an undefined attribute is a case where the attribute information of the components illustrated in the respective tables as illustrated in FIGS. 25 to 27 is not filled. The component estimation unit 126 can estimate the attribute information of the component by analyzing the information of the text (stage direction or line portion), referring to the general knowledge DB 147, or referring to the past work component DB 146. In addition, machine learning may be used for the estimation processing.

Here, FIG. 29 illustrates an example of a data configuration of the past work component DB 146. As illustrated in FIG. 29, the past work component DB 146 stores a character table, a relationship table of characters, a location table, a large props/props table, and the like in units of works. The component estimation unit 126 can refer to such past work component DB 146. For example, in the case of a series work, it is also assumed that the attribute information is acquired from the work name and the name of the character with reference to the past work component DB 146.

Subsequently, the importance determination unit 127 determines the importance of each component, and the label assigning unit 128 assigns an automatic/manual label on the basis of the determination result (step S221). Details of the importance determination and the labeling will be described later with reference to FIG. 32.

Next, the direction suggestion unit 1226 determines a component to be automatically generated and a component to be correctable/operable on the basis of the label of each component (step S224).

Next, the direction suggestion unit 1226 presents direction contents such as audio, lighting, and camerawork for each scene to the user (step S227).

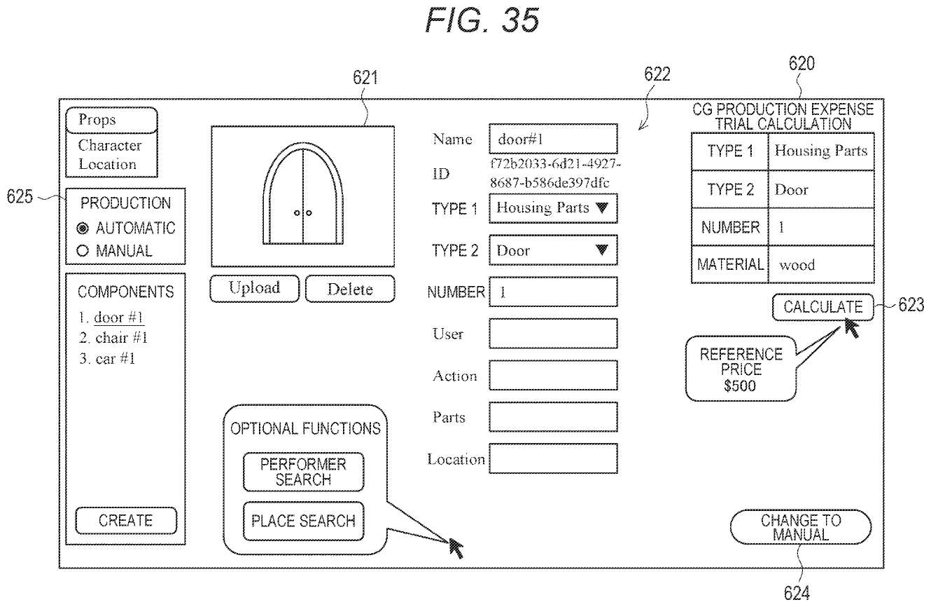

Next, the control unit 12B receives, from the input unit 11, correction of the component and the direction content by the user (step S230). The correction of the component can be performed, for example, from an editing screen of the component (see FIGS. 35 to 37). As an example, automatic/manual label changes can be made.

Next, the direction suggestion unit 1226 writes an instruction (components and direction contents) to be output to the command generation unit 1227 (generates a text file) (step S233). Note that, in a case where a user makes a correction to a component, the direction suggestion unit 1226 reflects the correction content in the current work component DB 145. Furthermore, at this point, the control unit 12B may transfer the entire metadata among the components stored in the current work component DB 145 to the past work component DB 146.

Next, the command generation unit 1227 generates a command for visualization (converts instructions by a text file into commands) on the basis of the instructions output from the direction suggestion unit 1226 (step S236). Specifically, the command generation unit 1227 performs command conversion of entire metadata and command conversion of time-series metadata.

In addition, the command generation unit 1227 complements the command as necessary (step S239). Specifically, the command generation unit 1227 complements the command in order to output a more detailed instruction to the visualization processing unit 1228 with reference to the command DB 14.

Next, the command generation unit 1227 stores the generated command in the command DB 14 (step S242).

Subsequently, the visualization processing unit 1228 searches for a 3DCG (asset) that can be corrected and operated in response to the command (step S245). Specifically, a search for a 3DCG (asset) that can be corrected and operated is performed for the component determined to be important and to which the manual label is assigned.

In addition, the visualization processing unit 1228 automatically generates an image by the generation model (learned data) in response to the command (step S248). Specifically, an image is automatically generated (imaged) for a component determined to be not important and assigned an automatic label.

Then, the visualization processing unit 1228 visualizes each scene (step S251). The video generated by the visualization is presented from the display unit to the user by the output control unit 123B. Note that sound may be output together.

Furthermore, the control unit 12B receives user's correction of the visualized video from the input unit 11 (step S254). Specifically, the posture, position, and the like of the 3DCG that can be corrected and operated included in the video can be corrected.

As described above, in the support of scenario production according to the second embodiment, when visualizing a scenario, importance is determined for each component extracted from the scenario, and components to be visualized by a correctable/operable method and components to be automatically generated are visualized separately. Although automatic generation can be performed using, for example, a generation model, correct output is not always performed, and in the present embodiment, important components are visualized by a correctable/operable method, thereby further improving user convenience. In addition, it is possible to appropriately reflect correction from the user between text analysis and visualization, and it is possible to support better scenario production.

### (Details of Extraction Processing)

Next, the extraction processing according to the present embodiment will be specifically described with reference to FIG. 23. FIG. 23 is a flowchart illustrating an example of a flow of extraction processing according to the second embodiment. Here, as an example, extraction of information regarding “characters” among the components will be described.

As illustrated in FIG. 23, when acquiring scenario data (step S303), the component extraction unit 121B extracts a stage direction, a line portion, and the like from the scenario data (step S306).

Next, the component extraction unit 121B extracts a name list of characters from the stage direction (step S309).

Next, the component extraction unit 121B determines whether or not the gender can be determined from the name (step S312). For example, a gender determination dictionary stored in the general knowledge DB 147 can be referred to. The gender determination dictionary is dictionary data in which a word whose gender can be determined and its gender are paired and stored, such as “WOMAN: Female, MAN: Male, he: Male, she: Female”.

Next, in a case where the gender can be determined (step S312/Yes), the component extraction unit 121B stores the corresponding gender in the current work component DB 145 as component data (step S315).

On the other hand, in a case where the gender cannot be determined (step S318/No), the component extraction unit 121B performs anaphoric analysis of the stage direction (step S318).

In a case where the component extraction unit 121B can determine the gender from the anaphora with reference to the gender determination dictionary (step S321/Yes), the component extraction unit stores the corresponding gender in the current work component DB 145 as component data (step S324).

On the other hand, in a case where the gender cannot be determined from the anaphora (step S321/No), the component extraction unit 121B parses the stage direction and extracts the equivalent word (step S327). For example, the component extraction unit 121B associates “MAY” with “aunt” from a sentence “MAY is Peter's aunt.”.

In a case where the component extraction unit 121B can determine the gender from the equivalent word with reference to the gender determination dictionary (step S330/Yes), the corresponding gender is stored in the current work component DB 145 as component data (step S333).

On the other hand, in a case where the gender cannot be determined from the equivalent word (step S330/No), the component extraction unit 121B stores “gender: undefined” as the component data in the current work component DB 145 (step S336).

### (Details of Estimation Processing)

Next, estimation processing according to the present embodiment will be specifically described with reference to FIG. 24. FIG. 24 is a flowchart illustrating an example of a flow of estimation processing according to the second embodiment. Here, as an example, estimation of the gender of a “character” among the components will be described.

As illustrated in FIG. 24, first, the component estimation unit 126 acquires the character table from the current work component DB 145 (step S353).

Next, the component estimation unit 126 specifies the person ID of a character with “gender: undefined” (step S356). Note that, in a case where there is no data of “gender: undefined”, the present processing ends.

Next, the component estimation unit 126 acquires the extracted attribute information of the corresponding person ID from the character table (step S359), and determines whether or not there is attribute information related to the gender (step S412).

Next, in a case where there is attribute information related to the gender (step S412/Yes), the component estimation unit 126 estimates the attribute information by the classification model from the related attribute information (step S415).

On the other hand, in a case where there is no attribute information related to the gender (step S412/No), the component estimation unit 126 acquires a line portion extracted from the scenario data (step S418). The scene heading, the stage direction, the line portion, and the like extracted from the scenario data by the component extraction unit 121B may be stored in the current work component DB 145.

Next, the component estimation unit 126 specifies and estimates gender-estimatable lines (step S421). For example, the output “Male” is obtained from the line “I'm a busy man, Mr. Parker.”

Then, in a case where the gender data can be output by the estimation using the classification model or the estimation from the line (step S424/Yes), the component estimation unit 126 stores the corresponding gender in the current work component DB 145 as component data (step S427). On the other hand, in a case where the gender data cannot be output (step S424/No), the present processing ends.

### (Details of Importance Determination and Labeling)

Next, processing of importance determination and labeling according to the present embodiment will be described. The importance of each component can be calculated on the basis of, for example, the number of appearances of the components. By determining the importance of each component, it is possible to divide the components into components that are automatically generated and components that can be corrected and operated at the time of visualization. Furthermore, it is possible to list up components (props and the like) that need to be particularly detailed and present the components to the user. In addition, it is possible for the user to browse important elements (important components) and grasp those that are highly likely to be cut out as a frame by the camerawork. Furthermore, by calculating the importance of each component not only for the overall importance but also for each scene, it is possible to use the calculated importance as a material for the user to consider a portion to be deleted when imaging (for example, a scene in the middle where only important components appear in the overall scene is redundant and is deleted or the like). In addition, the view of the world of the component to be corrected/operated (assumed to include addition, creation, and the like) by the user may be reflected in the component to be automatically generated in the same scene.

The definition of “important” is assumed to be, for example, (1) case where it appears frequently (an element having a large number of appearance scenes; Frequent Element), (2) element that is a key of the entire story (element with fine depicting); Crucial Element), and (3) element that is a key in the scene (it has a deep relationship with a component (for example, a main character) of Crucial Element in the scene; Focus Element). The importance of (1) may be determined on the basis of the number of appearances in the entire scenario (the entire story). The importance of (2) may be determined on the basis of whether or not the depiction is fine, that is, there is a lot of extracted attribute information. The importance of (3) is determined for each scene. Specifically, for example, in the case of “character”, the determination can be made on the basis of whether the number of lines of the person in the scene is large or the number of stage directions regarding the person is large. Furthermore, in the case of “location”, the determination can be made on the basis of whether or not it is a scene where the characters and the large props/props are not important (do not appear or the like). Furthermore, in the case of “large props/props”, the determination can be made on the basis of whether or not it has a deep relationship with Crucial Element, such as touched by Crucial Element (character or the like).

Hereinafter, a flow of operation processing will be described with reference to FIG. 32. FIG. 32 is a flowchart illustrating an example of a flow of processing of importance determination and labeling according to the second embodiment.

As illustrated in FIG. 32, first, the importance determination unit 127 acquires the component data extracted from the scenario (from the component extraction unit 121B or the current work component DB 145) (step S433).

Next, the importance determination unit 127 determines the importance of each component as a whole (entire scenario) (step S436). As a definition of the overall importance, the above-described “Frequent Element” and “Crucial Element” are assumed. For example, in the case of “Frequent Element”, in a case where the number of appearances exceeds a threshold, the importance determination unit 127 determines that the corresponding component is important (or of high importance, Main). In addition, in the case of “Crucial Element”, in a case where the number of pieces of extracted attribute information exceeds a threshold (for example, 10 or more pieces), the importance determination unit 127 determines that the corresponding component is important (or of high importance, Main). In addition, the importance determination unit 127 may calculate the importance of each component in consideration of the viewpoint of “Frequent Element” and the viewpoint of “Crucial Element”. For example, the importance determination unit 127 may calculate the importance (the number of points) by weighting the number of appearance scenes of each component according to the extracted attribute ratio of the component. Then, in a case where the importance is equal to or greater than the predetermined number of points, the component is determined to be an important element.

Next, the importance determination unit 127 updates the current work component DB 145 so as to add the determined importance as the attribute information of the component (step S439).

Note that the importance determination unit 127 can receive user's correction of the importance from the input unit 11 (step S442).

Subsequently, the importance determination unit 127 performs processing for each scene on the basis of the scenario information. Specifically, first, data of components appearing in the target scene is acquired (step S445).

Next, the importance determination unit 127 analyzes the header, stage direction, and line portions of the scenario in the target scene (step S448).

Next, the importance determination unit 127 determines the importance of the component in the target scene. As the definition of the importance in the scene, the above-described “Focus Element” is assumed. In the “Focus Element”, an element having a deep relationship such as touched by “Crucial Element” in the scene may be regarded as important (a predetermined point indicating the importance is given), or may be regarded as important in a case where the number of pieces of attribute information that can be extracted in the scene is larger (than a threshold). In addition, a component in which a predetermined feature word is used using machine learning may be important. Furthermore, the importance determination unit 127 may calculate the importance in a scene in consideration of the overall importance of the component that has already been calculated. For example, the importance determination unit 127 may set the sum of the overall importance and the importance in the scene calculated by the above method as the final importance of the component. Furthermore, the importance in the previous scene may be further added. Then, in a case where the importance is equal to or greater than a predetermined number of points, the importance determination unit 127 determines that the component is an important element. Further, the importance determination unit 127 may rank all the components appearing in the scene according to the importance or may rank the components by category.

Next, in a case where the component is a component that can be determined to be an important element (for example, the point of the importance exceeds the threshold) on the basis of the determination result of the importance (step S454/Yes), the label assigning unit 128 assigns a label (manual label) of correctable/operable (step S460).

On the other hand, in a case where it is not an important element (step S454/No), the label assigning unit 128 assigns a label of automatic generation (automatic label) (step S457).

Then, the label assigning unit 128 updates the current work component DB 145 to add a label to be assigned as attribute information of a component (step S463).

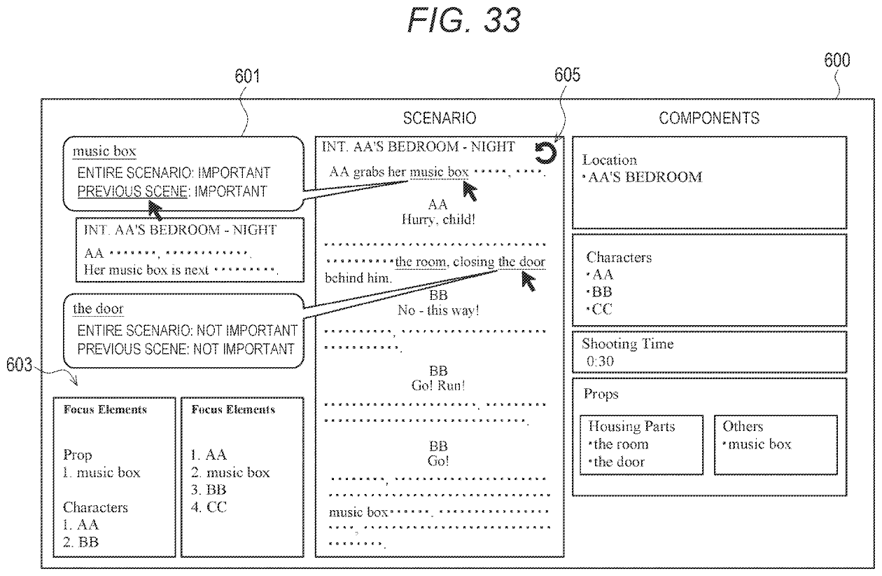

Note that the label assigning unit 128 can receive label replacement (change) by the user from the input unit 11 (step S446). The user can manually replace the automatic/manual label on each component from the editing screen (see FIGS. 33 and 35 to 37).

The processing of determining the importance and labeling according to the present embodiment has been described above. Note that the processing of determining the importance and labeling according to the present embodiment is not limited thereto. For example, the user may manually assign an automatic/manual label to each extracted component on the editing screen (see FIGS. 33 and 35 to 37).

In addition, when the scenario is corrected, the importance determination unit 127 may determine the importance of the corrected scene again and update the current work component DB 145. Furthermore, the importance determination unit 127 may periodically analyze the entire scenario to update the overall importance and the importance in the scene.

### 4-3. Display Screen Example

FIG. 33 is a diagram illustrating an example of an editing screen on which the importance and labels of components in a scene according to the second embodiment can be edited. As illustrated in the screen 600 of FIG. 33, when the cursor is placed on the word of the scenario body, the display 601 indicating the importance (whether or not it is an important element) is displayed for the component that has been extracted and whose importance has been determined. In addition, on the right side of the screen, extracted components are listed for each category. In addition, the display 603 of the important element in the scene is displayed on the left side of the screen. Here, the important element ranking by category and the ranking of all the important elements are displayed. The user may correct the demand by changing the order of the important element ranking, may correct the demand by deleting the component from the important element ranking, or may correct the demand by dragging the component from the scenario body into the area of Focus Elements on the screen. On the screen 600, the scenario body can also be corrected. In addition, when the update button 605 on the screen is selected, the importance determination unit 127 analyzes the scene again and updates the importance of the components.

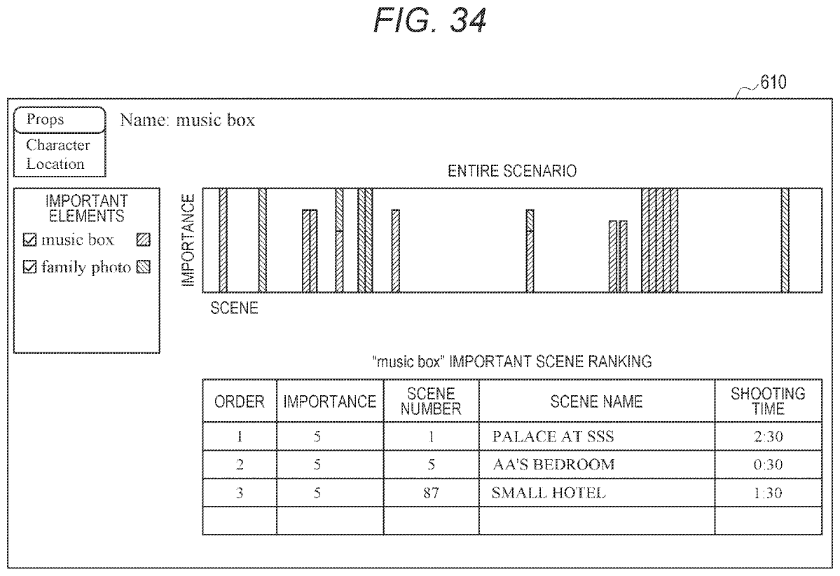

FIG. 34 is a diagram illustrating an example of an importance confirmation screen for each scene of appearance of a component according to the second embodiment. On the screen 610 in FIG. 34, a graph indicating the importance in the scene where the “music box” appears and a table indicating the importance ranking for each scene are displayed. In the graph indicating the importance in the scene, it is also possible to select and simultaneously display a plurality of components. The user can estimate the shooting cost (shooting time) and the schedule by referring to the appearance scene of the component in the entire scenario and the importance of each appearance scene.

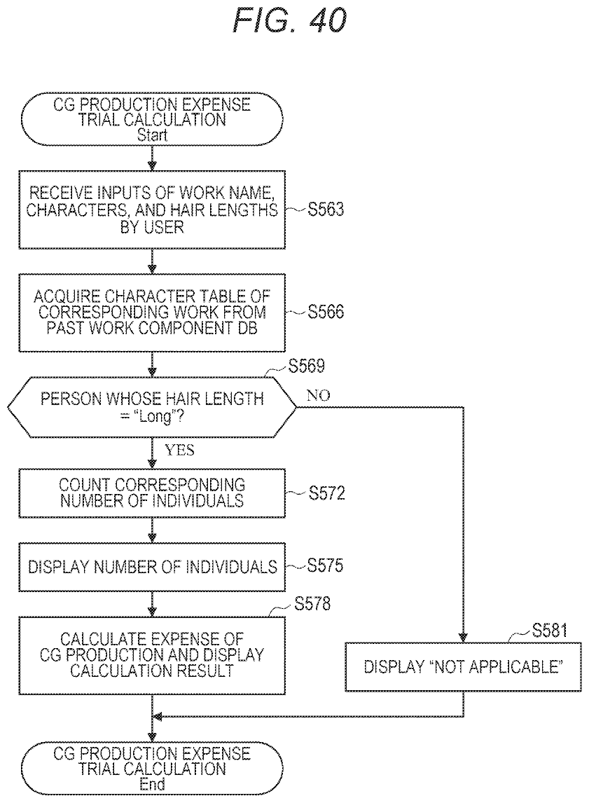

FIGS. 35 to 37 are diagrams illustrating an example of an editing screen of each component. Specifically, the screen 620 illustrated in FIG. 35 is an editing screen of large props (door) which is an example of a component. Here, the extracted attribute information 622 has already been input, and the user can manually correct the attribute information as appropriate or input the attribute information into a field that has not been extracted. In addition, the 2D image 621 automatically selected on the basis of the attribute information of the component can be displayed for reference. The 2D image 621 can be uploaded or deleted by the user. Furthermore, by selecting the “calculation” button 623, a trial calculation of the CG production expense of the component can be performed. The “CG production expense of the component” may assume a trial calculation of the production expense of the CG used for the actual video, or may assume a trial calculation of the production expense of the CG used for the simulation video. Details of the CG production expense trial calculation will be described later with reference to FIG. 40.

In addition, in the lower left part of the screen, the components can be displayed in the order of frequency. When the input of the attribute information of each component is completed, the user selects the “create” button and reflects the input content in the current work component DB 145.

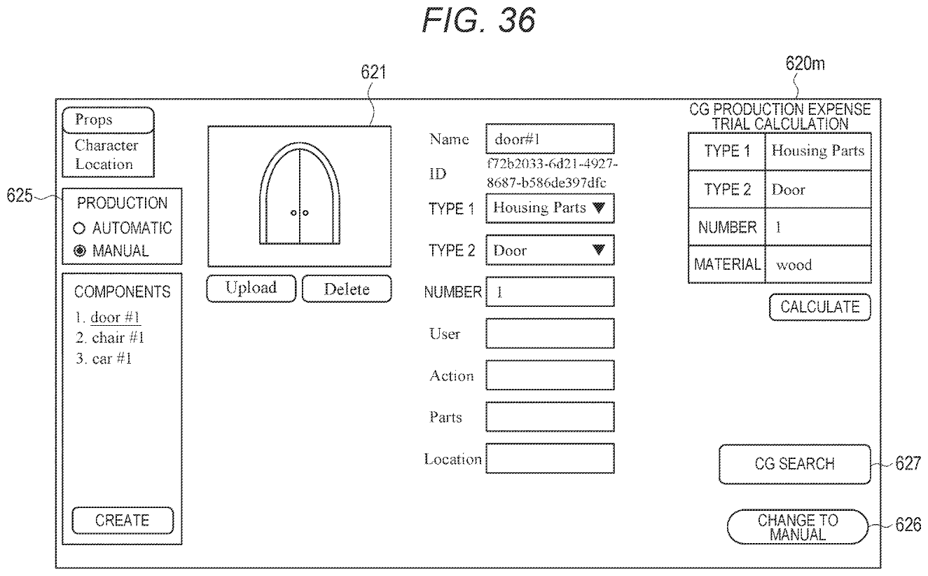

Furthermore, on the left side of the screen 620, the display 625 indicating a label (automatic/manual) regarding a production method at the time of visualization assigned to the component is displayed. In a case where the user desires to change the label (automatic/manual), the user selects the “change to manual” button 624 displayed at the lower right of the screen 620. When the “change to manual” button 624 is selected, the screen transitions to the editing screen 620 m illustrated in FIG. 36. At this time, the label of the component is changed from automatic to manual. In a case where the user desires to return to the automatic state, the user selects the “change to automatic” button 626. In addition, the “CG search” button 627 is displayed on the editing screen 620m. When the “CG search” button 627 is selected, a search for the 3DCG that can be corrected and operated by the user is performed. The 3DCG that can be corrected and operated by the user may be generated in advance.

Further, as an optional function, it is also possible to switch the screen to a performer search screen or a place search screen.

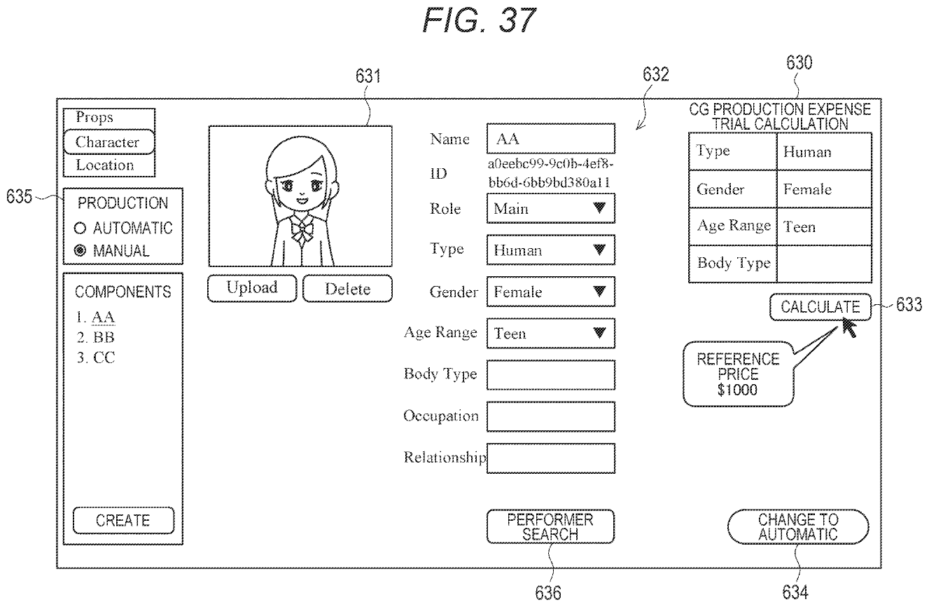

FIG. 37 is an editing screen for characters as an example of the components. Also on the screen 630 illustrated in FIG. 37, the extracted attribute information 632 has already been input, and the user can manually correct the attribute information as appropriate or input the attribute information in a field not extracted. In addition, the 2D image 631 automatically selected on the basis of the attribute information of the component can be displayed for reference. Furthermore, by selecting the “calculation” button 633, a trial calculation of the CG production expense of the component can be performed.

Furthermore, in the example illustrated in FIG. 37, the label of “manual” is assigned as illustrated in the display 635, but the user selects the “change to automatic” button 634 in a case where the user desires to change to automatic generation.

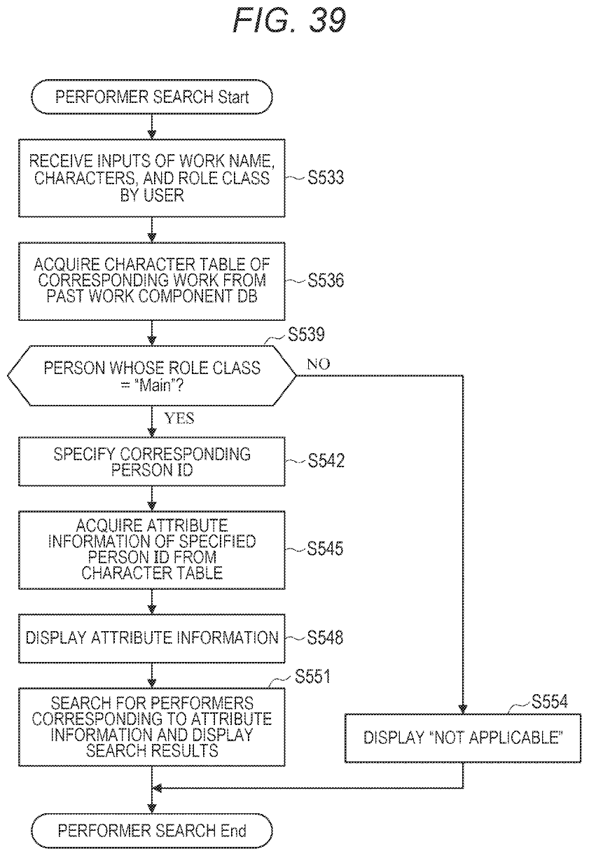

Further, by selecting the “performer search” button 636, an appropriate performer is searched on the basis of the attribute information of the characters, and the search result is displayed. The performer search will be described with reference to FIG. 39.

Although an example of the editing screen has been described above, each screen configuration illustrated in FIGS. 35 to 37 is an example, and the present embodiment is not limited thereto.

### 4-4. Application Example

Next, an application example of the second embodiment will be described. In the present embodiment, the performance of various searches and trial calculations can be improved on the basis of the attribute information of each component extracted/estimated from the information of the scenario.

### (Search Processing for Past Works Based on Place)

FIG. 38 is a flowchart illustrating an example of a flow of search processing of a past work based on a place according to an application example of the second embodiment. In the process of producing a movie, there is a need to refer to settings and videos of past works, such as “wanting to check camerawork of a movie in which a car chase scene appears”. In a case where there is no choice but to rely on human memory, or in web search or the like, there is a problem that it is difficult to reach required information or it takes time. In the present embodiment, it is possible to increase the search efficiency by managing the extracted/estimated information of each component in association with the work name (“work name oo location table” or the like).

As illustrated in FIG. 38, first, the search processing unit 1229 receives an input of a search word (for example, “Eiffel's Tower”) by the user from the input unit 11 (steps S503 and S505).

Next, the search processing unit 1229 acquires a location table of all works from the past work component DB 146 (step 3509).

Next, in a case where there is a location table including a component whose place name is “Eiffel's Tower” (step S512/Yes), the search processing unit 1229 specifies a location table name (for example, “work A_location table” or the like) (step S515) and further specifies a work name (for example, “work A”) (step S518).

Then, the search processing unit 1229 displays a specified work name list as a search result (step 3521). Note that, in a case where there is no location table including a component whose place name is “Eiffel's Tower” (step S512/No), the search processing unit 1229 displays “not applicable” as the search result.

### (Performer Search Processing)

FIG. 39 is a flowchart illustrating an example of a flow of performer search processing according to an application example of the second embodiment. Conventionally, when searching for a performer, it is necessary for a person to read a scenario and determine conditions (gender, age, height, or the like) necessary for the performer. However, in the present embodiment, by searching a performer database or the like inside and outside the system using attribute information of characters extracted/estimated from the scenario, it is possible to reduce time for confirming the scenario and labor for searching with human power.

As illustrated in FIG. 39, first, the search processing unit 1229 receives inputs of a work name, characters (components: characters), and a role class (“Main”) by the user (step S533).

Next, the search processing unit 1229 acquires the character table of the corresponding work from the past work component DB 146 (step S536). Note that, in the past work component DB 146, data of components in a scenario in which extraction/estimation of components and visualization processing have been performed has been transferred from the current work component DB 145. Even the information regarding the work before actual shooting can be stored as the information of the analyzed work.

Next, in a case where there is a person whose role class is “Main” (step S539/Yes), the search processing unit 1229 specifies the corresponding person ID (step S542) and acquires attribute information of the specified person ID from the character table (step S545).

Next, the search processing unit 1229 displays and presents the acquired attribute information to the user (step S548). In addition, the search processing unit 1229 searches for performers corresponding to the acquired attribute information from the performer database inside and outside the system, displays the search results, and presents the search results to the user (step S551). The performer search may be performed on an external website.

Note that, in a case where there is no person whose role class is “Main” (step S539/No), the search processing unit 1229 displays “not applicable” as the search result (step S554).

### (CG Production Expense Trial Calculation Processing)

FIG. 40 is a flowchart illustrating an example of a processing flow of a CG production expense trial calculation according to an application example of the second embodiment. In addition to CG production at the time of pre visualization creation, there are many cases where CG is used in actual video. However, there is a problem that man-hours and time are required for order preparation and expense estimation for CG production separately from reading the script. In a case of a character, it is necessary to perform element decomposition for order of CG parts more finely after a person reads the script and searches for an object to be converted into CG or the like. In the present system, since the object can be automatically extracted/estimated, it is possible to shorten the time. In addition, since extraction/estimation is performed in units of components for visualization, it is closer to units necessary for CG parts production than a general human sense, and information useful for CG order or production can be provided not only to a professional video production creator but also to a general user. Furthermore, if it is possible to predict how much the CG creation expense of the work will be from the script analysis result, it will help to reduce the time required for script selection. By comparing the estimated expense thus predicted and the budget, it is also possible to individually consider objects and scenes to be made into CG.

As illustrated in FIG. 40, first, the search processing unit 1229 receives inputs of a work name, characters, and hair lengths by the user (step S563). In this flow, as an example, a case will be described in which “the cost of CG production of all characters with long hair appearing in the work is estimated”.

Next, the search processing unit 1229 acquires the character table of the corresponding work from the past work component DB 146 (step S566).

Next, in a case where there is a person whose hair length is “Long” (step S569/Yes), the search processing unit 1229 counts the corresponding number of individuals (step S572) and displays the number of individuals (step S575). Furthermore, the search processing unit 1229 calculates the expense of CG production by the CG production expense trial calculation engine on the basis of the attribute information and the number of individuals of the target character, and displays the calculation result (step S578). The CG production expense trial calculation engine assumes a database and a calculation model that calculate expense and man-hours required for producing the 3DCG for visualizing each component.

Note that, in a case where there is no person whose hair length is “Long” (step S569/No), the search processing unit 1229 displays “not applicable” as the search result (step S581).

### (Shooting Cost Trial Calculation Processing)

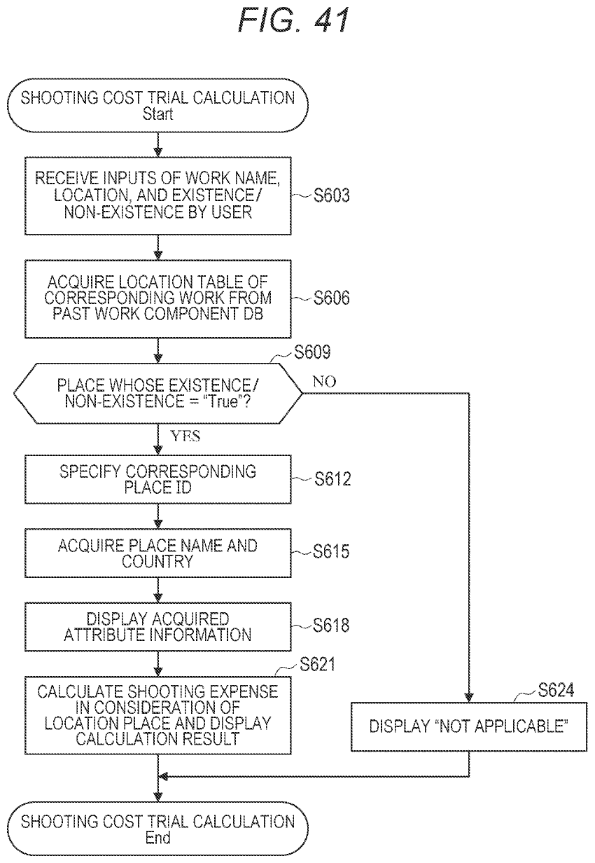

FIG. 41 is a flowchart illustrating an example of a flow of processing of a shooting cost trial calculation according to an application example of the second embodiment.

As illustrated in FIG. 41, first, the search processing unit 1229 receives inputs of a work name, a location, and existence/non-existence by the user (step S603). In this flow, as an example, a case of “acquiring a real place name and estimating the shooting cost” will be described.

Next, the search processing unit 1229 acquires the location table of the work from the past work component DB 146 (step S606).

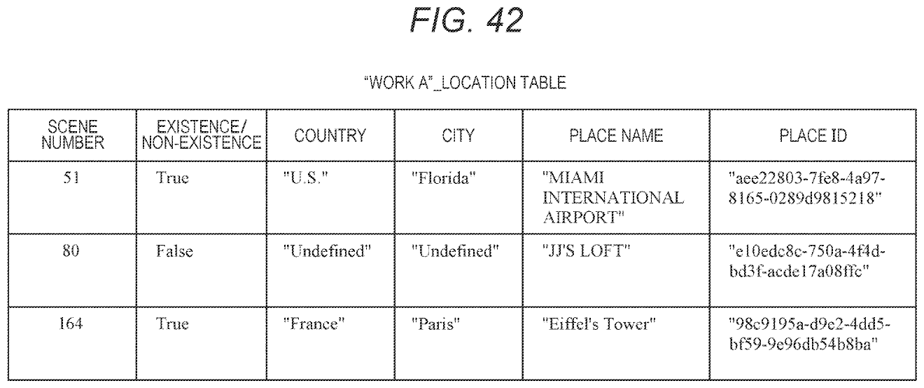

Next, in a case where there is a place whose existence/non-existence is “True” (step S609/Yes), the search processing unit 1229 specifies a corresponding place ID (step S612) and acquires a place name and a country (step S618). Here, FIG. 42 illustrates an example of a location database according to the present application example. As illustrated in FIG. 42, in the location database, a scene number, existence/non-existence, a country, a city, a place name, and a place ID that appear are associated as the attribute information of the location.

Next, the search processing unit 1229 displays the acquired attribute information (step S618). In addition, the search processing unit 1229 calculates the shooting expense in consideration of the location place (place of location) and displays the calculation result (step S621). The shooting expense is calculated using a shooting expense trial calculation engine. The shooting expense trial calculation engine assumes a process of calculating the expense of the shooting place and the like using a database storing the shooting place, the expense, and the like or an external website.

Note that, in a case where there is no place whose existence/non-existence is “True” (step S609/No), the search processing unit 1229 displays “not applicable” as the search result (step S624).

As described above, by estimating the estimation of the shooting cost on the basis of the location, it is possible to reduce the time for selection of a scenario and budget consideration. Furthermore, in the above-described step S618, the acquired attribute information (place name of a real location, country, city, scene number, or the like) is displayed, which is also useful in the case of setting a schedule of location shooting.

In addition, since the acquired attribute information also includes the scene number in which the location appears, for example, it is also possible to obtain a scene list in which the same place appears by sorting the search results by the place name of the location. As a result, the time required for work such as adjusting the schedule of location shooting and the shooting scene is also reduced. In addition, for example, in a case where schedule management is performed on a software basis or the like, the search processing can be utilized.

### (Prediction of Box-Office Revenue)

The output information generation unit 122B according to the present embodiment uses the learning data of the past work including the evaluation score of the audience, the evaluation score of the expert, and the like, so that it is also possible to predict the box-office revenue in a case where information of a new scenario is input. By referring to the prediction of the box-office revenue at the time of scenario selection, the selection time can be reduced. In addition, when describing the scenario, it is possible to write the scenario while confirming the prediction of the box-office revenue as one index. Furthermore, when a movie is produced based on a novel, the production process can proceed while referring to the prediction of the box-office revenue.

It is assumed that the prediction of the box-office revenue is calculated by creating a box office prediction model by a supervised learning method using a neural network. Furthermore, the learning data for model construction also includes information on characters and stages, an evaluation score of an audience, an evaluation score of an expert, and the like for past works that have been released. In the present embodiment, a part of the learning data can be obtained by performing analysis such as extraction/estimation of the information of the components on a large number of past works. Then, a model is constructed together with various evaluation data of past works or the like, and even when a new scenario is input, prediction of box-office revenue can be presented to the user as one of analysis results.

### 5. Supplement

While the preferred embodiments of the present disclosure have been described above in detail with reference to the accompanying drawings, the present technology is not limited to such examples. It is obvious that those with ordinary skill in the technical field of the present disclosure may conceive various modifications or corrections within the scope of the technical idea recited in claims, and it is naturally understood that they also fall within the technical scope of the present disclosure.

For example, it is also possible to create one or more computer programs for causing hardware such as the CPU, the ROM, and the RAM built in the information processing apparatus 1 described above to exhibit the functions of the information processing apparatus 1. Furthermore, a computer-readable storage medium that stores the one or more computer programs is also provided.

Furthermore, the effects described in the present specification are merely exemplary or illustrative, and are not restrictive. That is, the technology according to the present disclosure may exert other effects apparent to those skilled in the art from the description of the present specification in addition to or instead of the effects described above.

Note that the present technology may also have the following configurations.

(1)

An information processing apparatus including a control unit that performs:
a process of estimating a value caused by content on the basis of information of one or more of setting element set for generating the content;
a process of comparing the estimated value estimated with a target value; and
a process of outputting correction information regarding correction of the setting element on the basis of a result of comparison.

(2)

The information processing apparatus according to (1), in which the correction information is information regarding an increase or decrease in the number of the setting elements.

(3)

The information processing apparatus according to (2), in which the control unit determines a setting element to be added or deleted according to a difference between the estimated value and the target value.

(4)

The information processing apparatus according to (3), in which the control unit determines the setting element to be added or deleted by using learning data of content generated in a past.

(5)

The information processing apparatus according to (4), in which the control unit determines a setting element to be deleted from the one or more of the setting element.

(6)

The information processing apparatus according to (4), in which the control unit determines a setting element to be added from one or more of setting element of the content generated in the past.

(7)

The information processing apparatus according to any one of (1) to (6), in which the information of the setting element is information of a character, a person correlation, a location, a period, a prop, or a large prop of a story.

(8)

The information processing apparatus according to (7), in which the control unit performs a process of extracting the information of the setting element from information of a scenario.

(9)

The information processing apparatus according to (8), in which the value caused by the content is a temporal length of a video.

(10)

The information processing apparatus according to (8), in which the value caused by the content is a shooting cost or revenue.

(11)

The information processing apparatus according to any one of (1) to (10), in which the control unit performs control to generate one or more pieces of the correction information and display the generated one or more pieces of the correction information on a display unit as a change proposal.

(12)

The information processing apparatus according to (11), in which the control unit performs control to display the one or more pieces of the correction information as a card type UI.

(13)

The information processing apparatus according to any one of (1) to (12), in which the setting element is extracted from information of a scenario, and
the control unit performs control to display a range of a scenario affected by execution of the correction information in a case where the correction information is adopted by a user.

(14)

The information processing apparatus according to (1), in which the control unit is configured to:
determine importance of a component corresponding to the setting element on the basis of the information of the scenario, the importance being used to generate a simulation video on the basis of information of a scenario; and
among one or more of the component, determine a component that is visualized that can be operated by a user according to the importance.

(15)

An information processing method including
a processor that performs:
estimating a value caused by content on the basis of information of one or more of setting element set for generating the content;
comparing the estimated value estimated with a target value; and
outputting correction information regarding correction of the setting element on the basis of a result of comparison.

(16)

A program for causing a computer to function as a control unit that performs:
a process of estimating a value caused by content on the basis of information of one or more of setting element set for generating the content;
a process of comparing the estimated value estimated with a target value; and
a process of outputting correction information regarding correction of the setting element on the basis of a result of comparison.

### REFERENCE SIGNS LIST

1 Information processing apparatus
11 Input unit
12 (12A, 12B) Control unit
   121 Element extraction unit
   122 (122A, 122B) Output information generation unit
   123 (123A, 123B) Output control unit
13 Output unit
14 Storage unit
121A Setting element extraction unit
124 Tagging processing unit
1221 Estimation unit
1222 Comparison unit
1223 Correction information generation unit
1224 Display screen generation unit
141 Past work knowledge DB
142 Past work setting element DB
143 Setting element change history DB
121B Component extraction unit
126 Component estimation unit
127 Important determination unit
128 Label assigning unit
1226 Direction suggestion unit
1227 Command generation unit
1228 Visualization processing unit
145 Current work component DB
146 Past work component DB
147 General knowledge DB
148 Command DB 148

1. An information processing apparatus comprising a control unit that performs:
a process of estimating a value caused by content on a basis of information of one or more of setting element set for generating the content;
a process of comparing the estimated value estimated with a target value; and
a process of outputting correction information regarding correction of the setting element on a basis of a result of comparison.

2. The information processing apparatus according to claim 1, wherein the correction information is information regarding an increase or decrease in the number of the setting elements.

3. The information processing apparatus according to claim 2, wherein the control unit determines a setting element to be added or deleted according to a difference between the estimated value and the target value.

4. The information processing apparatus according to claim 3, wherein the control unit determines the setting element to be added or deleted by using learning data of content generated in a past.

5. The information processing apparatus according to claim 4, wherein the control unit determines a setting element to be deleted from the one or more of the setting element.

6. The information processing apparatus according to claim 4, wherein the control unit determines a setting element to be added from one or more of setting element of the content generated in the past.

7. The information processing apparatus according to claim 1, wherein the information of the setting element is information of a character, a person correlation, a location, a period, a prop, or a large prop of a story.

8. The information processing apparatus according to claim 7, wherein the control unit performs a process of extracting the information of the setting element from information of a scenario.

9. The information processing apparatus according to claim 8, wherein the value caused by the content is a temporal length of a video.

10. The information processing apparatus according to claim 8, wherein the value caused by the content is a shooting cost or revenue.

11. The information processing apparatus according to claim 1, wherein the control unit performs control to generate one or more pieces of the correction information and display the generated one or more pieces of the correction information on a display unit as a change proposal.

12. The information processing apparatus according to claim 11, wherein the control unit performs control to display the one or more pieces of the correction information as a card type UI.

13. The information processing apparatus according to claim 1, wherein the setting element is extracted from information of a scenario, and the control unit performs control to display a range of a scenario affected by execution of the correction information in a case where the correction information is adopted by a user.

14. The information processing apparatus according to claim 1, wherein the control unit is configured to:
determine importance of a component corresponding to the setting element on a basis of the information of the scenario, the importance being used to generate a simulation video on a basis of information of a scenario; and
among one or more of the component, determine a component that is visualized that can be operated by a user according to the importance.

15. An information processing method comprising
a processor that performs:
estimating a value caused by content on a basis of information of one or more of setting element set for generating the content;
comparing the estimated value estimated with a target value; and
outputting correction information regarding correction of the setting element on a basis of a result of comparison.

16. A program for causing a computer to function as a control unit that performs:
a process of estimating a value caused by content on a basis of information of one or more of setting element set for generating the content;
a process of comparing the estimated value estimated with a target value; and
a process of outputting correction information regarding correction of the setting element on a basis of a result of comparison.
